(19) United States
(12) Patent Application Publication
(10) Pub. No.: US 2026/0036429 A1
(43) Pub. Date: Feb. 5, 2026

(54) SYSTEMS AND METHODS FOR HYDROGEN REFUELING BASED ON WELL TO WHEEL EMISSIONS

(71) Applicant: Cummins Inc., Columbus, IN (US)

(72) Inventors: Jennifer Light-Holets, Greenwood, IN (US); Aaron Beinborn, Greenwood, IN (US); J. Steven Kolhouse, Columbus, IN (US)

(73) Assignee: Cummins Inc., Columbus, IN (US)

(21) Appl. No.: 19/288,121

(22) Filed: Aug. 1, 2025

Related U.S. Application Data
(60) Provisional application No. 63/679,066, filed on Aug. 2, 2024.

(51) Int. Cl. G01C 21/34; B60W 20/16; G01C 21/36

(52) U.S. Cl. CPC G01C 21/3415; B60W 20/16; G01C 21/3469; G01C 21/3679; B60W 2510/244

(57) ABSTRACT

A system includes a processing circuit configured to receive route information comprising a route of a first vehicle; receive a target well to wheel emissions value associated with at least the first vehicle; receive a first well to wheel emissions value regarding a first available fuel; comparing the first well to wheel emissions value to a predetermined threshold, the predetermined threshold based on the target well to wheel emissions value; identify a first fueling station associated with the first available fuel responsive to the first well to wheel emissions value being below the predetermined threshold; and modify the route of the first vehicle to include the first fueling station responsive to identifying the first fueling station.

### CROSS-REFERENCE TO RELATED APPLICATION

This U.S. Patent application claims the benefit and priority to U.S. Provisional Application No. 63/679,066, filed Aug. 2, 2024, which is incorporated herein by reference in its entirety and for all purposes.

### FIELD

The present disclosure relates to systems and methods for hydrogen refueling based on well to wheel characteristics, such as fuel consumption and/or emissions.

### BACKGROUND

A hydrogen fueled internal combustion engine consumes hydrogen fuel to produce power (e.g., for turning a crankshaft of a system embodying the engine, such as vehicle). Unlike internal combustion engines that burn carbonaceous fuel, such as diesel fuel or gasoline, the exhaust produced by a hydrogen internal combustion engine may not include hydrocarbons or carbon oxides (e.g., carbon monoxide or carbon dioxide). However, processes related to the production of hydrogen fuel may result in the release of carbon oxides. For example, an electrolyzer system used to produce hydrogen gas may consume electricity produced from fossil fuels (e.g., coal, oil, natural gas, etc.). The production of electricity may result in the release of carbon oxides and/or other pollutants, such as nitrogen oxides (NOx). Other processes related to the production of hydrogen fuel may similarly result in the release of carbon oxides, nitrogen oxides, and/or other pollutants.

### SUMMARY

One embodiment relates to a system including a processing circuit having one or more processors and one or more memory devices storing instructions that, when executed by the one or more processors, cause the one or more processors to perform operations. The operations include: receiving route information including a route of a first vehicle; receiving a target well to wheel emissions value associated with at least the first vehicle; receiving a first well to wheel emissions value regarding a first available fuel; comparing the first well to wheel emissions value to a predetermined threshold, the predetermined threshold based on the target well to wheel emissions value; identifying a first fueling station associated with the first available fuel, responsive to the first well to wheel emissions value being below the predetermined threshold; and modifying the route of the first vehicle to include the first fueling station, responsive to identifying the first fueling station.

Another embodiment relates to a method of auditing a refueling event. The method includes receiving an expected well to wheel emissions value; receiving an actual well to wheel emissions value; comparing a difference between the expected well to wheel emissions value and the actual well to wheel emissions value to a predetermined threshold; responsive to determining that the difference between the actual well to wheel emissions value and the expected well to wheel emissions value is below the predetermined threshold, providing a reporting data set to a third-party computing system; responsive to determining that the difference between the actual well to wheel emissions value and the expected well to wheel emissions value is at or above the predetermined threshold, performing operations including at least one of: implementing a vehicle derate via a controller of a vehicle, or modifying the reporting data set and sending the modified reporting data set to the third-party computing system.

Yet another embodiment relates to a method. The method includes receiving a route of a vehicle, the route including at least a first fueling station; receiving a first characteristic of a first fuel at the first fueling station; comparing the first characteristic of the first fuel to a predetermined characteristic; and responsive to the first characteristic being different than the predetermined characteristic, modifying the route to exclude the first fueling station.

Still another embodiment relates to a method. The method includes receiving a first characteristic of a first fuel at a first fueling station; receiving a second characteristic of a second fuel at a second fueling station; comparing the first characteristic to a predetermined characteristic; responsive to the first characteristic satisfying the predetermined characteristic, generating a first route that includes the first fueling station; responsive to the first characteristic being different than the predetermined characteristic, comparing the second characteristic to the predetermined characteristic; and responsive to the second characteristic satisfying the predetermined characteristic, generating a second route that includes the second fueling station.

In some embodiments, the method also includes: receiving a first cost value regarding the first fuel and a second cost value regarding the second fuel; responsive to the first characteristic satisfying the predetermined characteristic and the second characteristic satisfying the predetermined characteristic, receiving an indication that at least two fueling stations have a corresponding characteristic of an available fuel that satisfies the predetermined characteristic; responsive to the first cost value being less than the second cost value, generating the first route that includes the first fueling station; and responsive to the second cost value being less than the first cost value, generating the second route that includes the second fueling station.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a system, according to an example embodiment.

FIG. 2 is a block diagram of a vehicle of the system of FIG. 1, according to an example embodiment.

FIG. 3 is a flow diagram of a method of routing the vehicle of FIG. 2, according to an example embodiment.

FIG. 4 is a flow diagram of a method of auditing a fueling event of the vehicle of FIG. 2, according to an example embodiment.

FIG. 5 is a flow diagram of a method of routing the vehicle of FIG. 2 to a fueling station, according to an example embodiment.

FIG. 6 is a flow diagram of a method of generating a route for the vehicle of FIG. 2, according to an example embodiment.

FIG. 7 is a flow diagram of a method of identifying a fueling opportunity for the vehicle of FIG. 2, according to an example embodiment.

### DETAILED DESCRIPTION

Following below are more detailed descriptions of various concepts related to, and implementations of, methods, apparatuses, computer-readable media, and systems for hydrogen refueling based on well to wheel characteristic values, such as fueling and/or emission values. In some embodiments, one or more controls may be used to route a vehicle to a hydrogen refueling station based on one or more well to wheel emissions values. In some embodiments, the powertrain and fleet controls may be used to audit or verify at least one characteristic of a hydrogen refueling event based on one or more well to wheel emissions values. Before turning to the Figures, which illustrate certain exemplary embodiments in detail, it should be understood that the present disclosure is not limited to the details or methodology set forth in the description or illustrated in the Figures. It should also be understood that the terminology used herein is for the purpose of description only and should not be regarded as limiting.

As utilized herein, the term “estimating” and like terms are used to refer to determining an approximate value based on data (e.g., sensor data, historical sensor data, real-time sensor data, etc.), which may be close but not necessarily exactly the actual value. In some embodiments, estimating a current or future value can be performed using one or more models (e.g., statistical models, artificial intelligence models, machine learning models, etc.). For example, estimating a temperature of exhaust gas can include using data, such as sensor data, with a model to determine the temperature value.

As utilized herein, the term “measuring” and like terms are used to refer to determining an approximate value based on detecting or receiving information regarding the measured value/parameter (e.g., using a sensor). The measured value may be closer to the actual value (e.g., compared to estimating the value) but not necessarily exactly the actual value of the parameter value.

As utilized herein, a “well to wheel” emissions value refers to an amount of emissions produced from extraction, refinement, and usage in an end source (e.g., engine) of an energy source. For example, a well to wheel emissions value for a fuel (an energy source), such as hydrogen fuel, may include a summation of an amount of emissions associated with the production of the hydrogen fuel, the amount of emissions associated with the transportation of the hydrogen fuel, and the amount of emissions associated with the consumption of the hydrogen fuel. That is, the “well to wheel” emissions value includes a summation of the emissions emitted to produce, transport, and consume a fuel. The amount of emissions associated with the production of the hydrogen fuel may include, for example, the amount of emissions associated with the production of electricity to power an electrolyzer, the amount of emissions associated with the acquisition of materials for producing the hydrogen, such as water for an electrolysis process or coal for a gasification process, the amount of emissions associated with refining, purifying, or processing hydrogen gases produced by an electrolysis process into hydrogen fuel, and so on. The amount of emissions associated with the transportation of the hydrogen fuel may include the amount of emissions associated with transporting hydrogen fuel from a hydrogen fuel production location to a hydrogen fueling station (e.g., emissions released by a transportation truck). The amount of emissions associated with the consumption of the hydrogen fuel may include the amount of emissions produced by an internal combustion engine when consuming the hydrogen fuel.

In some embodiments, the well to wheel emissions value is based on “well to tank emissions value.” The well to tank emissions value refers to an amount of emissions emitted for a fuel, such as hydrogen fuel, associated with the production of the fuel and the transportation of the fuel to a storage tank, such as a fuel storage tank onboard a vehicle or a fuel storage tank configured to be coupled to a vehicle. More specifically, and regarding a hydrogen fuel, the well to tank emissions value may be a summation of an amount of emissions emitted to provide the hydrogen fuel to a hydrogen storage tank coupled to a combustion engine (e.g., a hydrogen storage tank onboard a vehicle). That is, the “well to tank” emissions value includes a summation of the emissions emitted to produce and transport a fuel to a fuel storage tank onboard a vehicle. In contrast with the “well to wheel” emissions value, the “well to tank” emissions value does not include the amount of emissions associated with the consumption of the fuel in the production of work.

In some embodiments, the well to tank emissions value is a measured value. For example, one or more emission constituent sensors (e.g., a NOx sensor, a SOx sensor, a carbon oxide sensor, etc.) may measure the amount of emissions emitted over a predefined amount of time and/or during the production of the fuel and the transportation of the fuel to the storage tank. The measured amount of well to tank emissions is referred to herein as an “actual well to tank emissions value.” In other embodiments, the well to tank emissions value is a determined or calculated value. For example, the amount of emissions emitted over a predefined amount of time and/or during the production of the fuel and the transportation of the fuel to the storage tank may be estimated using one or more of a lookup table or a model (e.g., a machine learning model, a statistical model, a mathematical model, etc.) that correlates the processed used to produce the fuel and the devices used to transport the fuel to the well to tank emissions value. The estimated amount of well to tank emissions is referred to herein as an “estimated well to tank emissions value.”

A “well to station” emissions value refers to an amount of emissions emitted for a fuel, such as hydrogen fuel, associated with the production of the fuel and the transportation of the fuel to a storage tank, such as a fuel storage tank at a refueling station. More specifically, and regarding a hydrogen fuel, the well to station emissions value may be a summation of an amount of emissions emitted to provide the hydrogen fuel to a hydrogen storage tank at a refueling station. Because the prosses of transferring a fuel from a storage tank at a refueling station to an onboard storage tank of a vehicle results in little to no emissions, the well to station emissions value and well to tank emissions value for a fuel may be numerically equivalent.

In some embodiments, the well to station emissions value is a measured value. For example, one or more emission constituent sensors (e.g., a NOx sensor, a SOx sensor, a carbon oxide sensor, etc.) may measure the amount of emissions emitted over a predefined amount of time and/or during the production of the fuel and the transportation of the fuel to the station. The measured amount of well to station emissions is referred to herein as an “actual well to station emissions value.” In other embodiments, the well to station emissions value is a determined or calculated value. For example, the amount of emissions emitted over a predefined amount of time and/or during the production of the fuel and the transportation of the fuel to the station may be estimated using one or more of a lookup table or a model (e.g., a machine learning model, a statistical model, a mathematical model, etc.) that correlates the processed used to produce the fuel and the devices used to transport the fuel to the well to station emissions value. The estimated amount of well to station emissions is referred to herein as an “estimated well to station emissions value.”

The well to wheel emissions value of a fuel may be determined based on the well to tank emissions value of the fuel and a “tank to wheel” emissions value. For example, the well to wheel emissions value of the fuel is or is based on a summation of the well to tank emissions value and the tank to wheel emissions value. The “tank to wheel” emissions value is an amount of emissions emitted by consuming the fuel. More specifically, the tank to wheel emissions value may be equivalent to an amount of emissions emitted by an internal combustion engine consuming the fuel minus an amount of emissions removed by an aftertreatment system. The aftertreatment system can remove emissions by, for example, capturing emissions (e.g., by one or more filter elements) or converting emissions (e.g., by one or more catalyst members and/or reductants) into another chemical, such as water and nitrogen gas (N₂). In some embodiments, the tank to wheel emissions value is a measured value. For example, one or more emission constituent sensors (e.g., a NOx sensor, a SOx sensor, a carbon oxide sensor, etc.) may measure the amount of emissions emitted over a predefined amount of time and/or during the operation of the engine system and the aftertreatment system. The measured amount of tank to wheel emissions is referred to herein as an “actual tank to wheel emissions value.” In other embodiments, the tank to wheel emissions value is a determined or calculated value. For example, the amount of emissions emitted over a predefined amount of time and/or during the operation of the engine and the aftertreatment system may be estimated using one or more of a lookup table or a model (e.g., a machine learning model, a statistical model, a mathematical model, etc.) that correlates the operations of the engine and/or the aftertreatment system to the tank to wheel emissions value. For example, the tank to wheel emissions value is based on one or more operational characteristics of the engine and/or the aftertreatment system, such as an engine speed, an engine torque, an engine temperature, an aftertreatment system temperature, a reductant to emissions constituent ratio (e.g., an ammonia to nitrogen oxide ratio, or “ANR”), and/or other operational characteristics of the engine or aftertreatment system. In some embodiments, the tank to wheel emissions value is based on one or more characteristics of the engine and/or the aftertreatment system, such as an engine displacement, an aftertreatment system configuration, and/or other characteristics of the engine and/or the aftertreatment system. The estimated amount of tank to wheel emissions is referred to herein as an “estimated tank to wheel emissions value.” In some embodiments, the estimated tank to wheel emissions value is a predicted value regarding a predicted amount of emissions produced by consuming the fuel.

As briefly described above, the well to wheel emissions value a fuel may be determined based on the summation of the well to tank emissions value of the fuel and the tank to wheel emissions value of the fuel. In some embodiments, when the well to wheel emissions value is determined using the actual tank to wheel emissions value, the well to wheel emissions value is referred to as an “actual well to wheel emissions value,” irrespective of whether the well to tank emissions value was measured or estimated. In other embodiments, when the well to wheel emissions value is determined using the estimated tank to wheel emissions value, the well to wheel emissions value is referred to as an “estimated well to wheel emissions value,” irrespective of whether the well to tank emissions value was measured or estimated. In yet other embodiments, the estimated well to wheel emissions is determined using the well to station emissions value and the estimated tank to wheel emissions value. In these embodiments, the estimated well to wheel emissions value for a fuel can be estimated while the fuel is at the fueling station (e.g., before a future potential fueling event where the fuel is transferred to a vehicle).

Based on the foregoing regarding well to wheel emissions value, a more detailed example may be with respect to hydrogen fuel as the fuel source. The well to wheel emissions value for the hydrogen fuel is based on, at least in part, a fuel source used to produce the hydrogen fuel (i.e., the fuel or fuels used to produce the hydrogen fuel itself). Classifications of hydrogen fuel may indicate the source of the hydrogen fuel. “Green hydrogen” is made by using clean electricity from surplus renewable energy sources, such as solar or wind power. The electricity is then used in an electrolysis process to produce the “green hydrogen.” “Blue hydrogen” is produced from natural gas, using a steam reforming process, which brings together natural gas and heated water in the form of steam. The output of the steam reforming process is hydrogen and carbon dioxide. The processes to produce “blue hydrogen” also includes the use of carbon capture and storage (CCS) to trap and store carbon dioxide byproducts. “Grey hydrogen” is produced from natural gas, or methane, using steam methane reformation but without capturing the greenhouse gases made in the process. Grey hydrogen is similar to blue hydrogen, but without the use of CCS. “Black hydrogen” and “brown hydrogen” are produced from black coal and brown coal, respectively. In particular, a gasification process is used to convert coal into hydrogen. “Pink hydrogen” is produced via an electrolysis process powered by nuclear energy. “Red hydrogen” is produced from biomass. Biomass can be transformed to produce hydrogen via a gasification process. Depending on the type of biomass and the use of carbon capture and storage technologies, red hydrogen can have lower CO2 emissions than grey hydrogen. “Turquoise hydrogen” is produced using a methane pyrolysis process to produce hydrogen and solid carbon. “Yellow hydrogen” is produced using an electrolysis process powered by solar energy. “White hydrogen” is a naturally occurring hydrogen.

As described herein, a powertrain system may include an engine. The engine may be a hydrogen internal combustion engine (ICE) configured to combust hydrogen fuel (H₂). During operation of the engine, a control system (e.g., a controller) may control operation of the powertrain and/or one or more components or systems thereof.

In an example embodiment, the control system may facilitate rerouting a vehicle embodying the powertrain, based on, for example, one or more well to wheel emissions values. For example, the control system may receive one or more well to wheel emissions values regarding an available hydrogen fuel at one or more hydrogen refueling stations. The control system may reroute the vehicle to a first hydrogen refueling station based on, for example, determining that the well to wheel emissions values regarding the available hydrogen fuel at the first hydrogen refueling station is at or below a predetermined value. Advantageously, by rerouting the vehicle to a refueling station having hydrogen with relatively lower well to wheel emissions values, the total emissions (e.g., total well to wheel emissions) associated with the vehicle may be improved (e.g., decreased).

In another example embodiment, the control system may facilitate auditing a fueling event associated with the powertrain based on, for example, one or more well to wheel emissions values. For example, the control system may receive one or more well to wheel emissions values, such as a well to wheel emissions value reported by a refueling station, a well to wheel emissions value reported by a powertrain operator (e.g., a user input, etc.). The control system may implement one or more controls responsive to a difference (e.g., a mathematical difference) between the well to wheel emissions value reported by the refueling station and the well to wheel emissions value reported by a powertrain operator being at or above a predetermined threshold. The one or more controls may include, for example, implementing a powertrain derate, implementing a fuel system control to prevent usage (e.g., by the engine) of at least a portion of the fuel received at the refueling event, modifying a reporting data packet to include the difference between the well to wheel emissions value reported by the refueling station and the well to wheel emissions value reported by powertrain operator, and/or causing the adjustment or modification of operations of one or more other vehicles in a fleet. Advantageously, by implementing one or more of the controls, the total emissions (e.g., total well to wheel emissions) associated with the vehicle and/or a fleet that includes the vehicle may be improved (e.g., decreased). These and other benefits are described more fully herein below.

In some embodiments, the control system may communicate with a remote computing system (e.g., a computing system located remotely from the powertrain). In some embodiments, the remote computing system may receive information from the control system of the system. In some embodiments, remote computing system may control operation of the powertrain of the system (e.g., by sending one or more commands, instructions, etc. to the control system of the system). The remote computing system may be configured to implement the processes, or portions thereof, described herein. For example, the remote computing system may facilitate rerouting one or more vehicles of a fleet (e.g., based on one or more well to wheel emissions values) and/or facilitate implementing one or more controls at one or more of the vehicles in the fleet (e.g., based on one or more well to wheel emissions values).

As used herein the term “controlling” and similar terms refer to maintaining and/or changing/modifying an operational parameter by generating and/or transmitting a control signal (e.g., by a controller, a computing system, etc.) to one or more systems, sensors, and/or components, such that the operation of the system, sensor, and/or component is managed or controlled. Such adjustments may be iterative, in which multiple adjustment are made until a desired output is reached. For example, a desired output may include a desired operational characteristic, a target and/or threshold value for an operational characteristic (e.g., a target emissions output, a target engine torque output, a target speed, a target fuel injection timing and/or quality, etc.). In some embodiments, the adjustment may be made based on a statistical model and/or a machine learning model (e.g., artificial intelligence). In these embodiments, the adjustments are not necessarily made in a pre-determined manner. Rather, the adjustments may become unique for the individual piece of equipment (engine, vehicle, operating environment, etc.).

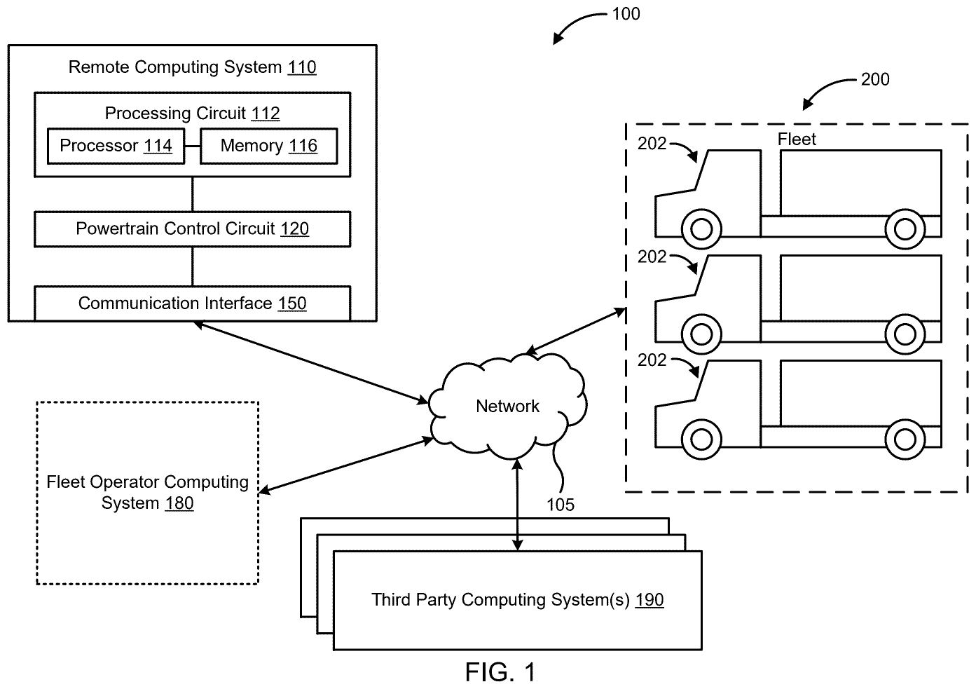

Now referring to FIG. 1, a block diagram of a system 100 is shown, according to an example embodiment. As shown in FIG. 1, the system 100 includes a network 105, a remote computing system 110, a fleet 200 of vehicles 202, and one or more third-party computing systems 190. Each or some of the components of the system 100 are in communication with each other and are coupled by the network 105. Specifically, the remote computing system 110, the third-party computing systems 190, and computing systems and/or vehicle controllers of the vehicles 202 of the fleet 200 are communicatively coupled to the network 105 such that the network 105 permits the direct or indirect exchange of data, values, instructions, messages, and the like (represented by the double-headed arrows in FIG. 1).

In some embodiments, the network 105 is configured to communicatively couple to additional computing system(s). In operation, the network 105 facilitates communication of data between the remote computing system 110 and other computing systems, such as the third-party computing systems 190 and/or the controllers of the vehicles 202. In some embodiments, the network facilitates communication of data between the remote computing system 110 and one or more computing systems associated with an operator of the fleet 200, shown as a fleet operator computing system 180. The fleet operator computing system 180 is described herein below.

The network 105 may include one or more of a cellular network, the Internet, Wi-Fi, Wi-Max, a proprietary provider network, a proprietary service provider network, and/or any other kind of wireless or wired network.

The remote computing system 110 is a computing system such as a server, a cloud computing system, and the like. Accordingly, as used herein, “remote computing system” can mean a computing or data processing system that has terminals distant from the central processing unit (e.g., processing circuit 112) from which users and/or other computing systems communicate with the central processing unit. Thus, the “remote computing system” can mean a computing or data processing system that is located remotely from a vehicle system, such as the vehicles 202 of the fleet 200. In some embodiments, the remote computing system 110 is part of a larger computing system such as a multi-purpose server, or other multi-purpose computing system. In other embodiments, the remote computing system 110 is implemented on a third-party computing device operated by a third-party service provider (e.g., AWS, Azure, GCP, and/or other third-party computing services).

In some embodiments, the remote computing system 110 is operated by a product and/or service provider (e.g., a business). Accordingly, in some embodiments, the remote computing system 110 is a service and/or system/component provider computing system and in turn controlled by, managed by, or otherwise associated with service and/or system/component provider (e.g., an engine manufacturer, a vehicle manufacturer, an exhaust aftertreatment system manufacturer, etc.). In the example shown, the remote computing system 110 is operated and managed by an engine manufacturer (which may also manufacture and commercialize other goods and services). Accordingly, an employee or other operator associated with the service and/or system/component provider may operate the remote computing system 110.

As shown in FIG. 1, the remote computing system 110 includes at least one processing circuit 112, one or more specialized processing circuits shown as a powertrain control circuit 120, and a communications interface 150. The processing circuit 112 is coupled to the powertrain control circuit 120, and/or the communications interface 150. The processing circuit 112 includes a processor 114 and a memory 116. The memory 116 is one or more devices (e.g., RAM, ROM, Flash memory, hard disk storage) for storing data and/or computer code for completing and/or facilitating the various processes described herein. The memory 116 is or includes non-transient volatile memory, non-volatile memory, and non-transitory computer storage media. The memory 116 includes database components, object code components, script components, or any other type of information structure for supporting the various activities and information structures described herein. The memory 116 is communicatively coupled to the processor 114 and includes computer code or instructions for executing one or more processes described herein. The processor 114 is implemented as one or more application specific integrated circuits (ASICs), field programmable gate arrays (FPGAs), a group of processing components, or other suitable electronic processing components. As such, the remote computing system 110 is configured to run a variety of application programs and store associated data in a database and/or the memory 116.

The communications interface 150 is structured to receive communications from and provide communications to other computing devices, users, and the like associated with the remote computing system 110. The communications interface 150 is structured to exchange data, communications, instructions, and the like with an input/output device of the components of the system 100. In some arrangements, the communications interface 150 includes communication circuitry for facilitating the exchange of data, values, messages, etc. between the communications interface 150 and the components of the remote computing system 110. In some arrangements, the communications interface 150 includes machine-readable media storing instructions for facilitating the exchange of information between the communications interface 150 and the components of the remote computing system 110. In some arrangements, the communications interface 150 includes any combination of hardware components, communication circuitry, and machine-readable media.

The communications interface 150 may include a network interface. The network interface is used to establish connections with other computing devices by way of the network 105. The network interface includes program logic that facilitates connection of the remote computing system 110 to the network 105. In some arrangements, the network interface includes any combination of a wireless network transceiver (e.g., a cellular modem, a Bluetooth transceiver, a Wi-Fi transceiver) and/or a wired network transceiver (e.g., an Ethernet transceiver). For example, the communications interface 150 includes an Ethernet device such as an Ethernet card and machine-readable media such as an Ethernet driver configured to facilitate connections with the network 105. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted.

In an example embodiment, the communications interface 150 is structured to receive information from one or more of the vehicles 202 of the fleet 200 and provide the information to the components of the remote computing system 110. The communications interface 150 is also structured to transmit instructions from the components of the remote computing system 110 to the vehicles 202 of the fleet 200.

The at least one memory 116 is configured to retrievably store data associated with the remote computing system 110 and/or any other component of the system 100. That is, the data includes information associated with each of the components of the system 100. For example, the data includes information about one or more vehicles 202 of the fleet 200. The information about the fleet 200 includes information received from one or more vehicles 202 (e.g., measured and/or estimated data values regarding the operation of the one or more vehicles 202), information determined by the remote computing system 110, and/or information about the one or more vehicles 202 (e.g., vehicle identification number, etc.). For example, the information includes a vehicle or equipment powertrain type (e.g., an internal combustion engine powered vehicle, a hybrid engine, a mild-hybrid powertrain, a parallel hybrid powertrain, a series hybrid powertrain, a series-parallel powertrain, etc.), a chassis type, a drag coefficient, tire sizes, tire pressures, a vehicle connectivity indicator (e.g., an ability of the vehicle to communicatively couple and/or coordinate operations to/with other vehicles), etc. The information may also include vehicle location information (e.g., GPS data over time, at a particular time, a current location, etc.). The information may also include engine information, such as an engine type (e.g., a spark ignition (SI), a compression ignition (CI) engine, etc.), an engine displacement, a fuel type, a fuel level (e.g., in gallons or other metric), and/or an engine health (e.g., based on one or more diagnostic indicators). The information may also include dynamic vehicle information, such as vehicle route information, such as a destination, expected traffic, expected and/or determined weather conditions, and/or route grade (e.g., changes in elevation) at various locations. The route information may also include a departure date and time, a departure location, expected stops (e.g., by GPS coordinates), estimated trip duration (e.g., in distance and time, etc.), etc. The route information may also include a current location of one or more of the vehicles 202, locations of fueling stations, distances between the vehicles 202 and one or more of the fueling stations, an indication of fueling stations within a predetermined distance of each of the vehicles 202, a distance between the route of each of the vehicles 202 and one or more of the fueling stations, and/or an indication of fueling stations within a predetermined distance of the route of each of the vehicles 202. The information may also include fuel characteristics, such as one or more well to tank emissions values associated with the fuel stored at each of the vehicles 202. In some embodiments, the fuel characteristics include one or more estimated well to wheel emissions values associated with the fuel stored at each of the vehicles 202. In some embodiments, the information also includes an identifier for a vehicle (e.g., the vehicle 202). The vehicle identifier is a unique code or string of alpha, numeric, and/or alpha-numeric values that is associated with a specific vehicle, such as a vehicle identification number (VIN), a serial number, an engine serial number, a fleet identifier, a controller IP address, and so on. In some embodiments, any of the information associated with the vehicles 202 of the fleet 200 may include metadata that includes the identifier such that the information can be associated with a particular vehicle.

In some embodiments, the memory 116 may store information received from the fleet operator computing system 180. In some embodiments, the information received from the fleet operator computing system 180 includes, for example, a target well to wheel emissions value for an individual vehicle 202 and/or for the fleet 200.

In some embodiments, the memory 116 may store information received from the third-party computing systems 190, such as information regarding one or more fueling stations including, for example, a well to station emissions value associated with a hydrogen fuel available at a corresponding fueling station. In some embodiments, the information received from the third-party computing systems 190 includes a history of emissions data requests, emissions tests for fleets, vehicles, engines, and/or engine cylinders, vehicle purchase history, vehicle sales history.

In some embodiments, the memory 116 may be configured to store one or more applications and/or executables to facilitate tracking data (e.g., data regarding the operation of the vehicles 202 in the fleet, such as actual well to wheel emissions value(s), location information, and/or other information described herein), managing incoming emissions data requests or emissions tests, managing on-vehicle control systems, or any other operation described herein. In some arrangements, the applications and/or executables are incorporated with an existing application in use by the remote computing system 110. In some arrangements, the applications and/or executables are separate software applications implemented on the remote computing system 110. The applications and/or executables may be downloaded by the remote computing system 110 prior to its usage, hard coded into the memory 116 of the processing circuit 112, or be a network-based or web-based interface application such that the remote computing system 110 provides a web browser to access the application, which may be executed remotely from the remote computing system 110 (e.g., by a user device). Accordingly, the remote computing system 110 includes software and/or hardware capable of implementing a network-based or web-based application. For example, in some instances, the applications and/or executables include software such as HTML, XML, WML, SGML, PHP (Hypertext Preprocessor), CGI, and like languages.

In some arrangements, the remote computing system 110 includes hardware, software, or any combination of hardware and software structured to facilitate operations of the components of the system 100. For example, and as shown in FIG. 1, the remote computing system 110 includes a powertrain control circuit 120 that includes any combination of hardware and software. In some embodiments, the remote computing system 110 includes any combination of hardware and software including specialized processing circuits, applications, executables, and the like for controlling, managing, or facilitating the operation of the other computing systems of the system 100 including the third-party computing systems 190 and computing systems of the vehicles 202 of the fleet 200. For example, the remote computing system 110 includes a powertrain control circuit 120 for controlling the operation of the vehicles 202 of the fleet 200.

In some embodiments, the powertrain control circuit 120 is configured to receive (e.g., via the communications interface 150) information about one or more of the vehicles 202 of the fleet 200 such as a well to tank emissions value regarding hydrogen fuel stored at each of the vehicles 202, an estimated well to wheel emissions value regarding hydrogen fuel stored at each of the vehicles 202, and/or an actual well to wheel emissions value regarding hydrogen fuel consumed by each of the vehicles 202.

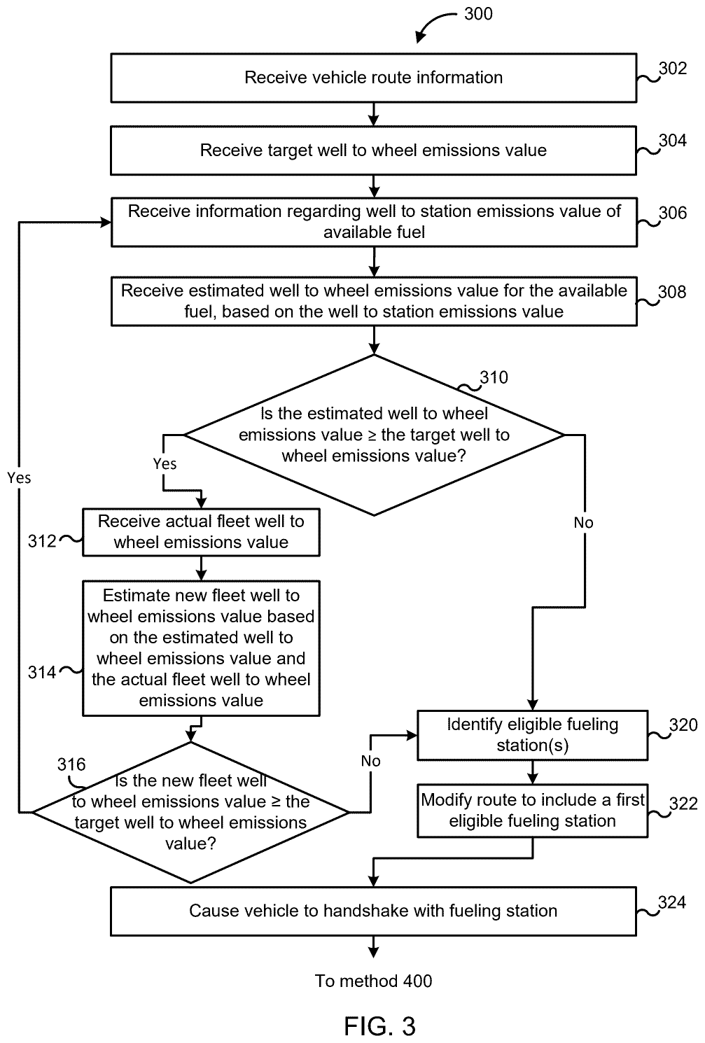

In some embodiments, the powertrain control circuit 120 is configured to receive information from the fleet operator computing system 180, such as a target well to wheel emissions value for one or more of the vehicles 202 and/or a target well to wheel emissions value for the fleet 200 as a whole. In some embodiments, the powertrain control circuit 120 is configured to receive information from the third-party computing systems 190, such as one or more well to tank emissions values corresponding to a hydrogen fuel available at one or more hydrogen refueling stations. For example, the third party associated with the system 190 may manufacture/produce the hydrogen fuel at one or more stations and, in turn, track such information. In various embodiments, the powertrain control circuit 120 is configured to determine a route for one or more of the vehicles 202 of the fleet 200. In some embodiments, the powertrain control circuit 120 is configured to determine the route based on the received information. More specific details regarding determining the route are described herein with respect to FIG. 3.

In some embodiments, the powertrain control circuit 120 is configured to receive (e.g., via the communications interface 150) information about the vehicles 202 of the fleet 200 such as a well to tank emissions value regarding a fuel received by the vehicles 202 during a refueling event and/or an estimated well to wheel emissions value regarding the fuel received by the vehicles 202 during the refueling event. As described herein, a “refueling event” refers to an event (e.g., an occurrence) of a vehicle 202 receiving fuel, such as hydrogen fuel. The vehicle 202 receives the hydrogen fuel from a hydrogen fueling station. In an example embodiment, the vehicle 202 receives the hydrogen fuel via a pressurized gas source that is configured to route pressurized hydrogen gas into a fuel storage device (e.g., a hydrogen storage tank) onboard the vehicle 202. In another example embodiment, the vehicle 202 receives a hydrogen storage tank that is pre-filled with hydrogen fuel. The received hydrogen storage tank may be fluidly coupled to a fuel system of the vehicle 202. In an example embodiment, the received hydrogen storage tank may be positioned in an open receptacle. In another example embodiment, the received hydrogen storage tank replaces a different hydrogen storage tank. For example, a first hydrogen storage tank coupled to the vehicle 202 may be removed from the vehicle and replaced with a second hydrogen storage tank that is at least partially filled with hydrogen fuel. The first hydrogen storage tank need not be empty or partially empty. That is, the first hydrogen storage tank may be full, at least partially full, or empty. In any of the above-described embodiments, the refueling event results in the vehicle 202 receiving new hydrogen.

In some embodiments, the powertrain control circuit 120 may receive additional information from the third-party computing systems 190, such as one or more well to tank emissions values corresponding to a hydrogen fuel available at one or more hydrogen refueling stations and/or one or more estimated well to wheel emissions values corresponding to the hydrogen fuel available at the one or more hydrogen refueling stations.

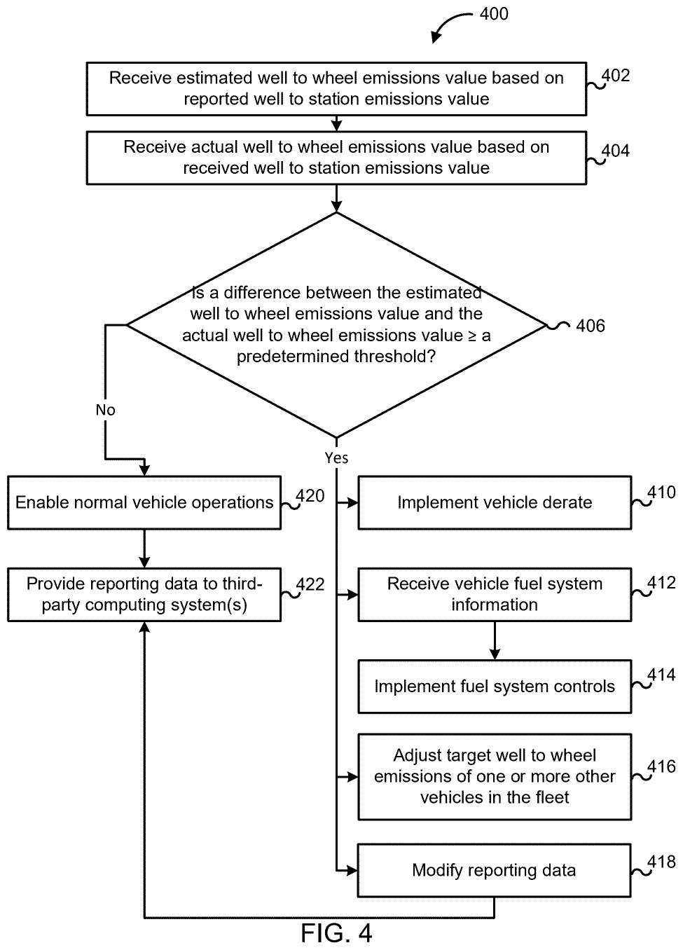

In various embodiments, the powertrain control circuit 120 is configured to verify the type of fuel provided to the vehicle 202 during the refueling event based on, for example, (i) receiving a well to station emissions value regarding the fuel received by the vehicle 202 during a refueling event (e.g., from one or more third party computing systems 190 associated with a fueling station of the fueling event), (ii) determining an estimated well to wheel emissions value based on the received well to station emissions value, and (iii) comparing the estimated well to wheel emissions value to an actual well to wheel emissions value. Details regarding verifying the fuel type provided to the vehicle 202 or otherwise auditing the refueling event are described herein with respect to FIG. 4.

In some embodiments, the fleet operator computing system 180 includes one or more computing systems associated with an operator of the fleet 200. In some embodiments, the fleet operator computing system 180 is at least one of a user device (e.g., a mobile device, smartphone, desktop computer, laptop computer, tablet, or any other suitable computing system). In some embodiments, the fleet operator computing system 180 is included in the remote computing system 110. In other embodiments, the fleet operator computing system 180 is included in the third-party computing systems 190. In still other embodiments, the fleet operator computing system 180 is a separate computing system. In some embodiments, the fleet operator computing system 180 includes processing circuitry that may be similar to the processing circuit 112 and a communications interface similar to the communications interface 150 such that the fleet operator computing system 180 is operable to communicate with the remote computing system 110 and/or the fleet 200 via the network 105.

In some embodiments, the fleet operator computing system 180 is configured to generate one or more reports. The one or more reports may include a human-readable summary of actual well to wheel emissions value regarding the operation of one or more vehicles 202 of the fleet 200 and/or actual wheel emissions value regarding the operation of the fleet 200 (e.g., graphics, text, etc.). The reports may be electronic documents, printable documents, provided via a graphical user interface, etc. In some embodiments and described in detailed herein below, the one or more reports are provided to at least one of the third-party computing systems 190. In some embodiments, the one or more reports are provided to at least one of the third-party computing systems 190 responsive to one or more of the third-party computing systems 190 sending a request to the fleet operator computing system 180, automatically based on a repeating request, and/or automatically without a request. In some embodiments, the reports are provided to the third-party computing system 190 in real-time. In other embodiments the reports are published (e.g., on a website or other remotely accessible medium) such that the third-party computing system 190 may access the reports remotely. In embodiments where the fleet operator computing system 180 is included in the remote computing system 110, the remote computing system 110 may generate the reports and/or provide the reports to one or more of the third-party computing systems 190.

In some embodiments, the fleet operator computing system 180 is configured to provide a fleet operator well to wheel target value. The fleet operator well to wheel target value is a well to wheel target value for a fleet or a subset of the fleet. In some embodiments, the fleet operator well to wheel target value is based on a user input (e.g., a user may indicate the value for the fleet operator well to wheel target value). For example, the fleet operator well to wheel target value may be based on a business goal, a user preference, or other suitable metric.

In some embodiments, the third-party computing systems 190 include one or more computing systems associated with one or more third parties (e.g., parties that are not the service provider). In some embodiments, the third-party computing systems 190 may include a computing system associated with a regulatory body (e.g., a government body, a government agency, etc.). The third-party computing systems 190 include processing circuitry that may be similar to the processing circuit 112 and a communications interface similar to the communications interface 150 such that the third-party computing systems 190 are operable to communicate with the remote computing system 110 and/or the fleet 200 via the network 105.

In some embodiments, the third-party computing systems 190 associated with the regulatory body are configured to provide a regulatory well to wheel target value. The regulatory well to wheel target value is based on a regulation (e.g., a rule or law set by the regulatory body). The regulation may correspond to a geographic area (e.g., a country, a region, a state, etc.), such that a vehicle (e.g., the vehicle 202) or fleet (e.g., the fleet 200) operating in the geographic area is required to operate with an actual well to wheel emissions value at or below a threshold set by the regulation. The third-party computing systems 190 may provide the regulatory well to wheel target value to the remote computing system 110.

In some embodiments, the third-party computing systems 190 may include computing systems associated with one or more fueling stations. In these embodiments, the third-party computing systems 190 associated with one or more fueling stations are configured to provide a well to station emissions value for hydrogen fuel available at the one or more fueling stations. In some embodiments, each fueling station may provide one or more types of hydrogen fuel (e.g., green hydrogen, yellow hydrogen, brown hydrogen, etc.), and, thus, each fueling station may have a corresponding well to station emissions value for each fuel type provided.

In some embodiments, the remote computing system 110 is configured to receive the well to station emissions values from the third-party computing systems 190. The remote computing system 110 is configured to determine an estimated well to wheel emissions value based on the received well to station emissions value. In some embodiments, remote computing system 110 is configured to determine the estimated well to wheel emissions value for one or more vehicles 202 of the fleet 200. For example, the remote computing system 110 may determine the estimated well to wheel emissions value for a vehicle 202 based on the received well to station emissions value (e.g., based on the type of fuel provided to the vehicle 202) and information regarding the vehicle 202. The information regarding the vehicle 202 may include, for example, one or more characteristics of the vehicle 202 (e.g., an engine type, an engine displacement, an aftertreatment system configuration, etc.) and/or one or more operational characteristics of the vehicle 202 (e.g., an engine speed, an engine torque, an aftertreatment system temperature, an aftertreatment system reductant to nitrogen oxide ratio, and so on).

As shown in FIG. 1, the fleet 200 includes one or more vehicles 202. In some embodiments, the fleet 200 includes more or fewer (e.g., at least one) vehicles. While shown as vehicles, in other embodiments, the fleet includes other equipment (e.g., gensets, etc.) in addition to or in place of the vehicle fleet. In yet other embodiments, the fleet includes off-road equipment (e.g., power generators, mining equipment, construction equipment, marine equipment, excavation equipment, etc.). The fleet 200 is associated with at least one of the service provider, a direct customer of the service provider, a third party customer, a location (e.g., a city, a state, a region, a country, etc.), a vehicle type (e.g., engine type, chassis type, workload type, etc.), and/or any other categorizing parameter associated with the vehicle. For example, the fleet 200 may be associated with a first customer, a first vehicle type, and a first region and may include one or more vehicles 202. In the example shown, the fleet 200 is associated with a third-party that operates, controls, uses, and/or is associated with the fleet operator computing system 180.

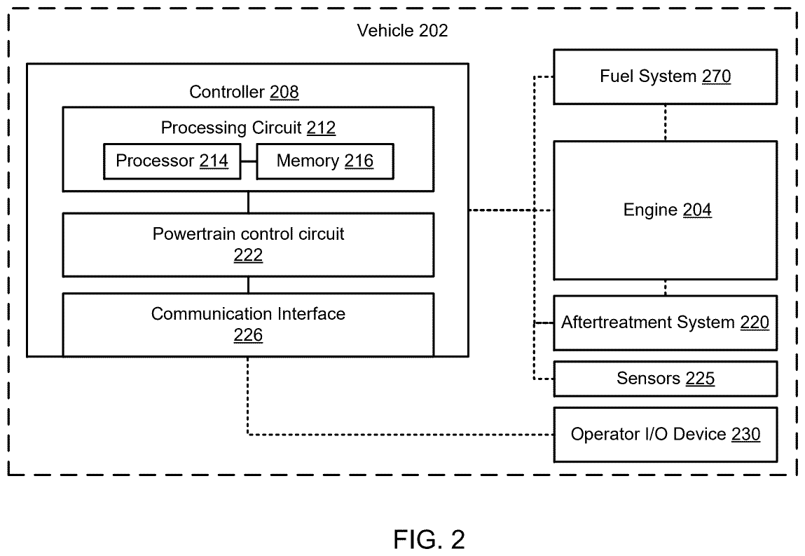

Referring now to FIG. 2, a schematic view of a block diagram of a vehicle 202 is shown, according to an example embodiment. The vehicle 202 includes an engine 204 and an aftertreatment system 220 in exhaust gas receiving communication with the engine 204. The vehicle 202 includes a fuel system 270 coupled to the engine 204 and configured to provide fuel (e.g., hydrogen fuel) to the engine 204. The vehicle 202 includes a controller 208 and an operator input/output (I/O) device 230, where the controller 208 is communicably coupled to each of the aforementioned components. In other embodiments, the components of the vehicle 202 may differ. Further, each vehicle 202 of the fleet may have a different structure (i.e., all the vehicles may not have the same structure).

In some embodiments, the vehicle 202 may be any type of on-road or off-road vehicle including, but not limited to, wheel-loaders, fork-lift trucks, line-haul trucks, mid-range trucks (e.g., pick-up truck, etc.), sedans, coupes, tanks, airplanes, boats, and any other type of vehicle. All such variations are intended to fall within the scope of the present disclosure.

In the configuration shown in FIG. 1, the engine 204 is a hydrogen internal combustion engine (ICE). The hydrogen ICE may consume hydrogen fuel to generate power. In some embodiments, the engine 204 may be part of a hybrid engine system having a combination of an internal combustion engine and at least one electric machine coupled to at least one battery (not shown). For example, the vehicle 202 may include an electric machine (e.g., a motor, a motor generator, an electric starter, an eAxle, etc.) that is coupled to the engine 204 via a shaft (e.g., an output shaft, a drive shaft, a crankshaft, etc.). In some embodiments, the vehicle 202 may be configured as a mild-hybrid powertrain, a parallel hybrid powertrain, a series hybrid powertrain, or a series-parallel powertrain.

The aftertreatment system 220 is in exhaust gas receiving communication with the engine 204. The aftertreatment system 220 includes components used to reduce exhaust emissions, such as a selective catalytic reduction (SCR) catalyst, an oxidation catalyst (OC), a particulate filter (PF), a plurality of sensors for monitoring the aftertreatment system (e.g., a nitrogen oxide (NOx) sensor, temperature sensors, etc.), and/or still other components.

In some embodiments, the aftertreatment system 220 includes a reductant delivery system (e.g., an exhaust fluid doser with a supply of exhaust fluid) which may include a decomposition chamber (e.g., decomposition reactor, reactor pipe, decomposition tube, reactor tube, etc.) to convert the reductant (e.g., urea, Adblue®, a urea water solution (UWS), an aqueous urea solution, etc.) into ammonia. The reductant delivery system is configured to provide the reductant to the exhaust gas stream to aid in the catalytic reduction. The reductant may be injected by an injector upstream of the SCR catalyst member such that the SCR catalyst member receives a mixture of the reductant and exhaust gas. The reductant droplets undergo the processes of evaporation, thermolysis, and hydrolysis to form non-NOx emissions (e.g., gaseous ammonia, etc.) within the decomposition chamber, the SCR catalyst member, and/or the exhaust gas conduit system, which leaves the aftertreatment system 220.

The fuel system 270 includes storage tanks, conduits, pumps, filters, and other components that is configured to route a fluid, such as hydrogen fuel, to the engine 204. The fuel system 270 is coupled to the engine 204. The fuel system 270 is configured to provide the hydrogen fuel to the engine 204. The fuel system 270 is configured to receive the hydrogen fuel (e.g., from a refueling station, from a removably coupled hydrogen storage tank, etc.).

In some embodiments, the fuel system 270 includes one or more fuel tanks configured to store the hydrogen fuel. In some embodiments, the one or more fuel tanks are removable such that each fuel tank may be removed and/or replaced. For example, an empty fuel tank may be replaced with a filled or partially filled fuel tank. In some embodiments, the fuel system 270 may selectively provide the hydrogen fuel to the engine 204 from one or more of the fuel tanks. For example, the fuel system 270 may provide the hydrogen fuel to the engine 204 from a first fuel tank of the one or more fuel tanks and subsequently provide fuel to the engine 204 from a second fuel tank of the one or more fuel tanks.

In some embodiments, when the engine 204 is part of a hybrid engine system, the fuel system 270 includes a battery. The battery may be coupled to an electric machine of the hybrid engine system. The fuel system 270 is configured to provide the electrical energy to the electric machine from the battery. In some embodiments, the fuel system 270 is configured to provide electrical energy to the battery from the electric machine and/or from an alternator coupled to the engine 204.

The operator input/output (I/O) 230 device may be coupled to the controller 208, such that information may be exchanged between the controller 208 and the I/O device 230, where the information may relate to one or more components of FIG. 2 or determinations (described below) of the controller 208. The operator I/O device 230 enables an operator of the vehicle 202 to communicate with the controller 208 and one or more components of the vehicle 202 of FIG. 2. For example, the operator input/output device 230 may include, but is not limited to, an interactive display, a touchscreen device, one or more buttons and switches, voice command receivers, etc. In this way, the operator input/output device 230 may provide one or more indications or notifications to an operator, such as a malfunction indicator lamp (MIL), etc. Additionally, the input/output device 230 may include a port that enables the controller 208 to connect or couple to a scan tool, such as a laser scanner, a camera, or other suitable scan tool. The scan tool may be configured to scan a code (e.g., a bar code, a QR code, etc.) and provide the scanned code to the controller 208. In this way, the controller 208 may receive information regarding a scanned code.

As shown, one or more sensors 225 are included in the vehicle 202. In some embodiments the number, placement, and type of sensors 225 may vary. The sensors 225 may be gas constituent sensors (e.g., NOₓ sensors, oxygen sensors, H₂O/humidity sensors, hydrogen sensors, etc.), temperature sensors, particulate matter (PM) sensors, flow rate sensors (e.g., mass flow rate sensors, volumetric flow rate sensors, etc.), other exhaust gas emissions constituent sensors, pressure sensors, some combination thereof, and so on. In an example embodiment, the sensors 225 are configured as temperature sensors configured to acquire data regarding a temperature of a fluid, such as the fuel system 270, air at or proximate the engine 204, or other fluid in the vehicle 202 and/or acquire data regarding a temperature of a component of the vehicle 202.

Additional sensors may be also included with the vehicle 202. The sensors may include engine-related sensors (e.g., torque sensors, speed sensors, pressure sensors, flowrate sensors, temperature sensors, etc.). The sensors 225 may further include sensors associated with other components of the vehicle, such as the aftertreatment system 220 or the fuel system 270.

The sensors 225 may be real or virtual (i.e., a non-physical sensor that is structured as program logic in the controller 208 that makes various estimations or determinations). For example, an engine speed sensor may be a real or virtual sensor arranged to measure or otherwise acquire data, values, or information indicative of a speed of the engine 204 (typically expressed in revolutions-per-minute). The sensor is coupled to the engine (when structured as a real sensor) and is structured to send a signal to the controller 208 indicative of the speed of the engine 204. When structured as a virtual sensor, at least one input may be used by the controller 208 in an algorithm, model, lookup table, etc. to determine or estimate a parameter of the engine (e.g., power output, etc.). Any of the sensors 225 described herein may be real or virtual.

The controller 208 is coupled, and particularly communicably coupled, to the sensors 225. Accordingly, the controller 208 is structured to receive data from one or more of the sensors 225 and provide instructions/information to the one or more sensors 225. The received data may be used by the controller 208 to control one or more components in the vehicle 202 as described herein.

The controller 208 is structured to control, at least partly, the operation of the vehicle 202 and associated sub-systems, such as the engine 204 and the operator I/O device 230. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 208 is communicably coupled to the systems and components of FIG. 2, the controller 208 is structured to receive data from one or more of the components shown in FIG. 2.

As the components of FIG. 2 are shown to be embodied in the vehicle 202, the controller 208 may be structured as one or more electronic control units (ECUs), such as one or more microcontrollers. The controller 208 may be separate from or included with at least one of a transmission control unit, an exhaust aftertreatment control unit, a powertrain control module, an engine control unit, an engine control module, etc.

As shown, the controller 208 includes at least one processing circuit 212 having at least one processor 214 and at least one memory device 216, a powertrain control circuit 222, and a communications interface 226. The controller 208 is structured to control operation of the other components of the vehicle 202. In some embodiments, the controller 208 may control operation of the fuel system 270, the engine 204, and/or other components of the vehicle 202 to achieve a desired or target well to wheel emissions value. For example, the controller 208 may operate one or more valves, motors, actuators, heaters, or other suitable devices to achieve the target well to wheel emissions value.

In one configuration, the powertrain control circuit 222 is embodied as machine or computer-readable media storing instructions that are executable by a processor, such as processor 214. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media instructions may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the powertrain control circuit 222 is embodied as one or more hardware units, such as one or more electronic control units. As such, the powertrain control circuit 222 may be embodied as one or more circuitry components including, but not limited to, processing circuitry, network interfaces, peripheral devices, input devices, output devices, sensors, etc. In some embodiments, the powertrain control circuit 222 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the powertrain control circuit 222 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. The powertrain control circuit 222 may also include or be programmable hardware devices such as field programmable gate arrays, programmable array logic, programmable logic devices or the like. The powertrain control circuit may include one or more memory devices for storing instructions that are executable by the processor(s) of the powertrain control circuit 222. The one or more memory devices and processor(s) may have the same definition as provided below with respect to the memory device 216 and processor 214. In some hardware unit configurations, the powertrain control circuit 222 may be geographically dispersed throughout separate locations in the vehicle 202. Alternatively, and as shown, the powertrain control circuit 222 may be embodied in or within a single unit/housing, which is shown as the controller 208.

In the example shown, the controller 208 includes the at least one processing circuit 212 having the at least one processor 214 and the at least one memory device 216. The processing circuit 212 may be structured or configured to execute or implement the instructions, commands, and/or control processes described herein with respect to the powertrain control circuit 222. The depicted configuration represents the powertrain control circuit 222 as being embodied as machine or computer-readable media storing instructions (which may be stored by the at least one memory device 216). However, as mentioned above, this illustration is not meant to be limiting as the present disclosure contemplates other embodiments where the powertrain control circuit 222 is configured as a hardware unit. All such combinations and variations are intended to fall within the scope of the present disclosure.

The processor 214 may be implemented as one or more single- or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the powertrain control circuit 222 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The at least one memory device 216 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 216 may include dynamic random-access memory (DRAM). The memory device 216 may be communicably connected to the processor 214 to provide computer code or instructions to the processor 214 for executing at least some of the processes described herein. Moreover, the memory device 216 may be or include tangible, non-transient volatile memory or non-volatile memory. Accordingly, the memory device 216 may include database components, object code components, script components, or any other type of information structure for supporting the various activities and information structures described herein.

The communications interface 226 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., with a remote server). For example, and regarding out-of-vehicle/system communications, the communications interface 226 may include an Ethernet card and port for sending and receiving data via an Ethernet-based communications network and/or a Wi-Fi transceiver for communicating via a wireless communications network. The communications interface 226 may be structured to communicate via local area networks or wide area networks (e.g., the Internet) and may use a variety of communications protocols (e.g., IP, LON, Bluetooth, ZigBee, radio, cellular, near field communication).

As shown in FIG. 2, the communications interface 226 may enable communication with the engine 204, the aftertreatment system 220 (and/or a component thereof), the one or more sensors (not shown), the fuel system 270 and/or the operator I/O device 230.

The powertrain control circuit 222 is configured to receive data regarding a well to tank emissions value of a fuel received by the vehicle 202. In some embodiments, powertrain control circuit 222 is configured to receive data regarding a well to station emissions value regarding a fuel that is available to the vehicle 202 (e.g., fuel that the vehicle 202 can receive from a refueling station).

In some embodiments, the powertrain control circuit 222 is configured to receive data regarding an estimated well to wheel emissions value. The estimated well to wheel emissions value is determined based on an estimated tank to wheel emissions value and one of the received well to tank emissions value or the received well to station emissions value. In some embodiments, the estimated well to wheel emissions value is determined by the controller 208, or one or more components thereof, such as the powertrain control circuit 222. In some embodiments, the estimated well to wheel emissions value is determined by the remote computing system 110, and the controller 208 receives the estimated well to wheel emissions value from the remote computing system 110. In other embodiments, the estimated well to wheel emissions value is determined by at least one of the third-party computing systems 190, and the controller 208 receives the estimated well to wheel emissions value from the at least one third-party computing system 190.

In some embodiments, the powertrain control circuit 222 is configured to receive data regarding an actual well to wheel emissions value. The actual well to wheel emissions value is based on a corresponding well to tank emissions value and the actual tank to wheel emissions value.

In other embodiments of the vehicle 202, one or more components or systems of the vehicle 202 shown in FIG. 2 may be omitted.

Now referring to FIG. 3, a flow diagram of a method 300 of facilitating a refueling event is shown, according to an example embodiment. In some embodiments, the remote computing system 110, or a component thereof, such as the powertrain control circuit 120, is structured to perform the method 300 alone, or in combination with one or more components/systems of the system 100, such as one or more vehicles 202 of the fleet 200, the fleet operator computing system 180, and/or the third-party computing systems 190. In an example embodiment, the method 300 includes facilitating a refueling event for at least one vehicle 202 of the fleet 200, such as a first vehicle 202. Accordingly, in the embodiments described herein, the method 300 relates to facilitating a refueling event for the first vehicle 202. However, it should be understood that the method 300 may be performed concurrently, partially concurrently, and/or sequentially for each vehicle 202 in the fleet 200. For example, the remote computing system 110 may perform the method 300 for each vehicle 202 in the fleet 200. It should be understood that certain of the method 300 processes may be combined in other embodiments; implemented in a different order than depicted in other embodiments; and, in some embodiments, certain of the method 300 processes may be deleted/omitted.

At process 302, the remote computing system 110 receives vehicle route information regarding a first vehicle 202 of the fleet 200. In some embodiments, the vehicle route information includes an origin location, a destination location, a route (e.g., roads, paths, highways, that the vehicle 202 will use to travel from the origin location to the destination location), expected traffic along the route, expected and/or determined weather conditions, and/or route grade (e.g., changes in elevation) at various locations along the route, turn-by-turn directions, and/or other information regarding the route of the first vehicle. In some embodiments, the route information includes a location of one or more refueling stations that are within a predetermined distance of the route. For example, the route information may include a location of one or more fueling stations where a distance between the each refueling station and the route of the first vehicle is at or below a predetermined distance threshold. In some embodiments, the route information regarding the first vehicle 202 includes a current location of the first vehicle 202 based on, for example, a GPS location of the first vehicle 202.

At process 304, the remote computing system 110 receives a target well to wheel emissions value. In some embodiments, the target well to wheel emissions value corresponds to the first vehicle 202. In some embodiments, the target well to wheel emissions value is a maximum amount of well to wheel emissions emitted by the first vehicle of the fleet 200 during a predetermined period of time (e.g., one day, one month, one year, etc.) or per unit of fuel (e.g., per liter of fuel, per pound of fuel, etc.).

In some embodiments, the remote computing system 110 may receive a target well to wheel emissions value corresponding to the fleet 200. The target well to wheel emissions value is a maximum amount of well to wheel emissions emitted by all of the vehicles 202 in the fleet 200 during a predetermined period of time (e.g., one day, one month, one year, etc.) or per unit of fuel (e.g., per liter of fuel, per pound of fuel, etc.).

In some embodiments, the target well to wheel emissions value is the fleet operator well to wheel target value. In these embodiments, the remote computing system 110 may receive the target well to wheel emissions value from the fleet operator computing system 180. As described above, the target well to wheel emissions value may be based on a business goal, a user preference, or other suitable metric.

In other embodiments, the target well to wheel emissions value is the regulatory well to wheel target value. In these embodiments, the remote computing system 110 may receive the target well to wheel emissions value from the third-party computing systems 190 associated with the regulatory body. As described above, the regulatory well to wheel target value may be based on a regulation (e.g., a rule or law set by the regulatory body). In some embodiments, the regulation may correspond to a geographic area (e.g., a country, a region, a state, etc.), such that a vehicle (e.g., the vehicle 202) or fleet (e.g., the fleet 200) operating in the geographic area is required to operate using fuel having a well to wheel emissions value at or below a threshold set by the regulation. When the regulatory well to wheel target value corresponds to a geographic area, the remote computing system 110 may receive the regulatory well to wheel target value responsive to the first vehicle 202 being within the geographic area. For example, the remote computing system 110 may receive a geographic location of at least one vehicle 202 in the fleet 200, such as the first vehicle 202, and receive the regulatory well to wheel target value responsive to the at least one vehicle 202 being within the geographic area corresponding to the regulatory well to wheel target value. In any of the above-described embodiments, the third-party computing systems 190 may provide the regulatory well to wheel target value to the remote computing system 110.

At process 306, the remote computing system 110 receives information regarding one or more well to station emissions values of available fuel. The available fuel may be hydrogen fuel that is available to the first vehicle 202. The available fuel may be provided by a corresponding refueling station. In some embodiments, the remote computing system 110 is configured to receive information from at least one of the third-party computing systems 190 regarding a well to station emissions values of available fuel at each of a plurality of refueling stations. In some embodiments, each refueling station of the plurality of refueling stations is located within a predetermined geographic area, such as an area where the vehicles 202 of the fleet 200 operate. In some embodiments, each refueling station of the plurality of refueling stations is located within a predetermined distance of the route of the first vehicle 202 and/or within a predetermined distance of the first vehicle 202. For example, the remote computing system 110 may receive information regarding a first well to station emissions value of a first fuel available at a first refueling station. In some embodiments, a distance between the first refueling station and a first vehicle 202 may be at or below a predetermined distance threshold. In some embodiments, a distance between the first refueling station and the route of the first vehicle may be at or below a predetermined distance threshold. A distance between a particular location, such as a refueling station, or, more specifically, the first refueling station, and a route, such as the route of the first vehicle, may be a shortest available on-road distance between the route and the particular location including, for example, highways, on/off ramps, roads, streets, etc. In some embodiments, the distance between a particular location and a route includes a round-trip distance from the route to the particular location and back to the route. In some embodiments, the predetermined distance threshold is based on, for example, an amount of fuel stored by a fuel system, such as the fuel system 270, onboard the first vehicle 202. For example, as the amount of fuel stored by the fuel system, the predetermined distance threshold may decrease.

At process 308, the remote computing system 110 receives an estimated well to wheel emissions value for the available fuel, based on the well to station emissions value. As described above, the estimated well to wheel emissions value for the available fuel is determined prior to a potential fueling event (e.g., before the fuel is transferred from a fueling station to the vehicle 202). The remote computing system 110 may determine the estimated tank to wheel emissions value for the available fuel based on, for example, one or more operational characteristics of the vehicle 202, such as an engine speed, an engine torque, an engine temperature, an aftertreatment system temperature, a reductant to emissions constituent ratio (e.g., an ammonia to nitrogen oxide ratio, or “ANR”), and/or other operational characteristics of the vehicle 202 and/or one or more characteristics of the vehicle 202, such as an engine displacement, an aftertreatment system configuration, and/or other characteristics of the vehicle 202. The remote computing system 110 determine the estimated well to wheel emissions value for the available fuel based on a summation of the estimated tank to wheel emissions value and the received well to station emissions value.

At process 310, the remote computing system 110 compares the estimated well to wheel emissions value of the available fuel to the target well to wheel emissions value. The target well to wheel emissions value may be the target well to wheel emissions value of the first vehicle 202 and/or the target well to wheel emissions value of the fleet 200. In an example embodiment, the remote computing system 110 compares a first estimated well to wheel emissions value of a first available fuel to the predetermined threshold. In some embodiments, the remote computing system 110 may repeat process 310 for each estimated well to wheel emissions value received at process 308 (e.g., a first estimated well to wheel emissions value of a first available fuel, a second estimated well to wheel emissions value of a second available fuel, and so on). Responsive to the estimated well to wheel emissions value of the available fuel being at or above the target well to wheel emissions value, the remote computing system 110 may proceed to process 312. In some embodiments, the remote computing system 110 may determine that, because the estimated well to wheel emissions value regarding the available fuel (e.g., the first fuel) is at or above the target well to wheel emissions value, refueling the first vehicle with the first available fuel (e.g., the first fuel) would result in the actual well to wheel emissions value regarding the first vehicle 202 exceeding the target well to wheel emissions value. That is, refueling the first vehicle with the first available fuel would result in the amount of emissions emitted by the first vehicle 202 exceeding a predetermined threshold. To mitigate the first vehicle 202 emitting more emissions than the predetermined threshold amount of emissions, the remote computing system 110 may determine whether refueling the first vehicle 202 with the available fuel would cause a cumulative amount of well to wheel emissions emitted by the fleet 200 to exceed a target well to wheel emissions value of the fleet 200, as described in process 312, process 314, and process 316. Advantageously, the remote computing system 110 may allow the first vehicle 202 to refuel using the available fuel corresponding to an estimated well to wheel emissions value that is at or above the target well to wheel emissions value, so long as an estimated well to wheel emissions value corresponding to the fleet 200 (e.g., a “fleet estimated well to wheel emissions value”) remains below the predetermined threshold corresponding to the fleet. Responsive to the estimated well to wheel emissions value of the available fuel being below the target well to wheel emissions value, the remote computing system 110 may proceed to process 320.

At process 312, the remote computing system 110 receives an actual fleet well to wheel emissions value. In some embodiments, the actual fleet well to wheel emissions value is a cumulative amount of well to wheel emissions emitted by the vehicles 202 in the fleet 200. In some embodiments, the remote computing system 110 receives the actual fleet well to wheel emissions value responsive to the estimated well to wheel emissions value of the available fuel being at or above the target well to wheel emissions value.

At process 314, the remote computing system 110 estimates a new fleet well to wheel emissions value based on the estimated well to wheel emissions value received at process 308 and the actual fleet well to wheel emissions value received at process 312. More specifically, the remote computing system 110 may estimate the cumulative amount of well to wheel emissions emitted by the vehicles 202 in the fleet 200 if the first vehicle 202 was refused using the first available fuel (e.g., the first fuel) corresponding to the estimated well to wheel emissions value that is at or above the target well to wheel emissions value, as determined at process 310.

At process 316, the remote computing system 110 compares the new estimated fleet well to wheel emissions value to the target well to wheel emissions value. The target well to wheel emissions value may be the target well to wheel emissions value of the fleet 200. Responsive to the new estimated fleet well to wheel emissions value being at or above the target well to wheel emissions value, the remote computing system 110 may return to process 306. In some embodiments, when returning to process 306, the remote computing system 110 may receive an additional well to station emissions value regarding an available fuel, such as a second well to station emissions value regarding a second fuel. The remote computing system 110 may repeat process 306, process 308, and process 310 (and optionally repeat process 312, process 314, and process 316) for the second well to station emissions value regarding the second fuel and/or subsequent well to station emissions values regarding corresponding fuel.

In some embodiments, the remote computing system 110 may determine that, because the new estimated fleet well to wheel emissions value is at or above the target well to wheel emissions value, refueling the first vehicle with the first available fuel (e.g., the first fuel) would result in the actual fleet well to wheel emissions value exceeding the target well to wheel emissions value. That is, refueling the first vehicle with the first available fuel would result in the cumulative amount of emissions emitted by the fleet 200 exceeding a predetermined fleet threshold. Advantageously, to mitigate the fleet 200 emitting more emissions than the predetermined fleet threshold amount of emissions, the remote computing system 110 may determine that the refueling station having the first available fuel is not an eligible refueling station. Further, the remote computing system 110 may prevent the vehicle 202 from traveling to the refueling station having the first available fuel (e.g., by preventing the rerouting of the vehicle to the refueling station having the first available fuel).

Responsive to the new estimated fleet well to wheel emissions value being below the target well to wheel emissions value, the remote computing system 110 may proceed to process 320. In some embodiments, the remote computing system 110 may determine that, because the new estimated fleet well to wheel emissions value is below the target well to wheel emissions value, refueling the first vehicle with the first available fuel (e.g., the first fuel) would result in the actual fleet well to wheel emissions value being below the target well to wheel emissions value. That is, refueling the first vehicle 202 with the first available fuel would result in the cumulative amount of emissions emitted by the fleet 200 being below the predetermined fleet threshold.

At process 320, the remote computing system 110 may identify one or more refueling station as an “eligible refueling station.” In some embodiments, an “eligible refueling station” is a refueling station having an available fuel corresponds to an estimated well to wheel emissions value that is at or below the predetermined threshold. In other embodiments, an “eligible refueling station” is a refueling station having an available fuel with a corresponding estimated well to wheel emissions value that, if used in a vehicle 202 of the fleet 200, would not cause a fleet well to wheel emissions value to exceed a corresponding threshold. Advantageously, and as described above, the remote computing system 110 may allow the first vehicle 202 to refuel using the available fuel having an estimated well to wheel emissions value at or above the predetermined threshold, so long as the estimated fleet well to wheel emissions value remains below the predetermined threshold corresponding to the fleet.

In an example embodiment, the remote computing system 110 may determine that a first refueling station having the first available fuel is an eligible refueling station (e.g., based on any of the criteria described above). The remote computing system 110 may repeat process 320 for subsequently received well to station emissions values that have a corresponding estimated well to wheel emissions value (received at process 308) that is either (i) at or below a predetermined threshold (as determined at process 310) or (ii) would not cause the fleet well to wheel emissions value to exceed a corresponding threshold (as determined at process 316). In some embodiments, when the remote computing system 110 repeats process 320, the remote computing system 110 may identify a refueling station having an available fuel with a lowest well to wheel emissions value.

At process 322, the remote computing system 110 modifies the route of the first vehicle 202 to include the at least one eligible refueling station identified at process 320. In some embodiments, when the remote computing system 110 identified more than one eligible refueling station, the remote computing system 110 modifies the route of the first vehicle 202 to include the refueling station having the available fuel with the lowest well to wheel emissions value (e.g., a first eligible fueling station). In some embodiments, modifying the route of the first vehicle 202 to include the at least one eligible refueling station (e.g., rerouting the vehicle 202) includes causing the operator I/O device 230 of the vehicle 202 to display the modified route. For example, modifying the route may include directing an operator of the vehicle to the eligible refueling station (e.g., a nearest refueling station or other eligible refueling station).

At process 324, the remote computing system 110 causes the first vehicle to perform a “handshake” with the refueling station. As described herein, a “handshake” between a vehicle and a refueling station refers to an exchange of data between a computing system associated with the vehicle, such as a control system or controller (e.g., the controller 208) and a computing system associated with the refueling station, such as one or more of the third-party computing systems 190. In an example embodiment, the handshake includes the controller 208 sending the third-party computing system 190 a first well to station emissions value regarding the available fuel at a first refueling station. The first well to station emissions value regarding the available fuel at the first refueling station may be one of the well to station emissions values received at process 306. The controller 208 may subsequently receive, from the third-party computing system 190, (i) an indication that the fuel available at the first refueling station has a well to station emissions value that is at or above the first well to station emissions value or (ii) an indication that the fuel available at the first refueling station has a well to station emissions value that is below the first well to wheel emissions value. Responsive to receiving the indication that the fuel available at the first refueling station has a well to station emissions value that is at or above the first well to wheel emissions value, the controller 208 may send a request to the remote computing system 110 for a different refueling station, and the remote computing system 110 may return to process 322 to reroute the vehicle 202 to a second refueling station, different than the first refueling station and/or the remote computing system 110 may return to process 306 to receive a second well to station emissions value. Responsive to receiving the indication that the fuel available at the first refueling station has a well to station emissions value that is below the first well to station emissions value, the controller 208 may send a signal to the remote computing system 110 indicating that the vehicle 202 will proceed to the first refueling station. In some embodiments, after process 324, the remote computing system 110 may perform the method 400 to audit the refueling event.

In various other embodiments of the method 300, the controller 208, or one or more components thereof, such as the powertrain control circuit 222, may perform the method 300 alone, or in combination with one or more components/systems of the system 100, such as the remote computing system 110, the fleet operator computing system 180, and/or the third-party computing systems 190.

For example, when the method 300 is performed by the controller 208, at process 302, controller 208 receives vehicle route information regarding the vehicle 202. In some embodiments, the vehicle route information includes an origin location, a destination location, a route (e.g., roads, paths, highways, that the vehicle 202 will use to travel from the origin location to the destination location), expected traffic along the route, expected and/or determined weather conditions, and/or route grade (e.g., changes in elevation) at various locations along the route, turn-by-turn directions, and/or other information regarding the route of the first vehicle. In some embodiments, the route information includes a location of one or more refueling stations that are within a predetermined distance of the route. For example, the route information may include a location of one or more fueling stations where a distance between the each refueling station and the route of the first vehicle is at or below a predetermined distance threshold. In some embodiments, the route information regarding the vehicle 202 includes a current location of the vehicle 202 based on, for example, a GPS location of the vehicle 202.

At process 304, the controller 208 receives a target well to wheel emissions value. In some embodiments, the target well to wheel emissions value corresponds to the vehicle 202. In some embodiments, the target well to wheel emissions value is a maximum amount of well to wheel emissions emitted by the vehicle 202 during a predetermined period of time (e.g., one day, one month, one year, etc.) or per unit of fuel (e.g., per liter of fuel, per pound of fuel, etc.).

In some embodiments, the target well to wheel emissions value is the fleet operator well to wheel target value. In these embodiments, the controller 208 may receive the target well to wheel emissions value from the fleet operator computing system 180. As described above, the target well to wheel emissions value may be based on a business goal, a user preference, or other suitable metric.

In other embodiments, the target well to wheel emissions value is the regulatory well to wheel target value. In these embodiments, the controller 208 may receive the target well to wheel emissions value from the third-party computing systems 190 associated with the regulatory body. As described above, the regulatory well to wheel target value may be based on a regulation (e.g., a rule or law set by the regulatory body). In some embodiments, the regulation may correspond to a geographic area (e.g., a country, a region, a state, etc.), such that when the vehicle 202 operates in the geographic area the vehicle 202 is required to operate using fuel having a well to wheel emissions value at or below a threshold set by the regulation. When the regulatory well to wheel target value corresponds to a geographic area, the controller 208 may receive the regulatory well to wheel target value responsive to the vehicle 202 being within the geographic area. For example, the controller 208 may receive a geographic location of the vehicle 202 and receive the regulatory well to wheel target value responsive to the vehicle 202 being within the geographic area corresponding to the regulatory well to wheel target value. In any of the above-described embodiments, the third-party computing systems 190 may provide the regulatory well to wheel target value to the controller 208.

At process 306, the controller 208 receives information regarding one or more well to station emissions values of available fuel. The available fuel may be hydrogen fuel that is available for providing to the vehicle 202 for consumption by the vehicle 202. The available fuel may be provided by a corresponding refueling station. In some embodiments, the controller 208 is configured to receive information from at least one of the third-party computing systems 190 regarding a well to station emissions values of available fuel at each of a plurality of refueling stations. In some embodiments, each refueling station of the plurality of refueling stations is located within a predetermined geographic area, such as an area within a predetermined distance of the vehicle 202. In some embodiments, each refueling station of the plurality of refueling stations is located within a predetermined distance of the route of the vehicle 202 and/or within a predetermined distance of the vehicle 202. For example, the controller 208 may receive information regarding a first well to station emissions value of a first fuel available at a first refueling station. In some embodiments, a distance between the first refueling station and the vehicle 202 may be at or below a predetermined distance threshold. In some embodiments, a distance between the first refueling station and the route of the vehicle 202 may be at or below a predetermined distance threshold. In some embodiments, the predetermined distance threshold is based on, for example, an amount of fuel stored by the fuel system 270. For example, as the amount of fuel stored by the fuel system 270, the predetermined distance threshold may decrease.

At process 308, the controller 208 receives an estimated well to wheel emissions value for the available fuel, based on the well to station emissions value. As described above, the estimated well to wheel emissions value for the available fuel is determined prior to a potential fueling event (e.g., before the fuel is transferred from a fueling station to the vehicle 202). The controller 208 may determine the estimated tank to wheel emissions value for the available fuel based on, for example, one or more operational characteristics of the vehicle 202, such as an engine speed, an engine torque, an engine temperature, an aftertreatment system temperature, a reductant to emissions constituent ratio (e.g., an ammonia to nitrogen oxide ratio, or “ANR”), and/or other operational characteristics of the vehicle 202 and/or one or more characteristics of the vehicle 202, such as an engine displacement, an aftertreatment system configuration, and/or other characteristics of the vehicle 202. The controller 208 determine the estimated well to wheel emissions value for the available fuel based on a summation of the estimated tank to wheel emissions value and the received well to station emissions value.

At process 310, the controller 208 compares the estimated well to wheel emissions value of the available fuel to the target well to wheel emissions value. The target well to wheel emissions value may be the target well to wheel emissions value of the vehicle 202. In an example embodiment, the controller 208 compares a first estimated well to wheel emissions value of a first available fuel to the target well to wheel emissions value. In some embodiments, the controller 208 may repeat process 310 for each estimated well to wheel emissions value received at process 308 (e.g., a first estimated well to wheel emissions value of a first available fuel, a second estimated well to wheel emissions value of a second available fuel, and so on). Responsive to the estimated well to wheel emissions value of the available fuel being at or above the target well to wheel emissions value, the controller 208 may return to process 306. That is, when the controller 208 performs the method 300, the controller 208 does not perform process 312, process 314 and process 316. Responsive to the estimated well to wheel emissions value of the available fuel being below the target well to wheel emissions value, the controller 208 may proceed to process 320.

At process 320, the controller 208 may identify one or more refueling station as an “eligible refueling station.” In some embodiments, an “eligible refueling station” is a refueling station having an available fuel with a corresponding estimated well to wheel emissions value that is at or below the target well to wheel emissions value.

In an example embodiment, the controller 208 may determine that a first refueling station having the first available fuel is an eligible refueling station (e.g., based on any of the criteria described above). The controller 208 may repeat process 320 for subsequently received estimated well to wheel emissions values that are at or below a predetermined threshold (as determined at process 310). In some embodiments, when the controller 208 repeats process 320, the controller 208 may identify a refueling station having an available fuel with a lowest estimated well to wheel emissions value.

At process 322, the controller 208 modifies the route of the vehicle 202 to include the at least one eligible refueling station identified at process 320. In some embodiments, when the controller 208 identified more than one eligible refueling station, the controller 208 modifies the route of the vehicle 202 to include the refueling station having the available fuel corresponding to the lowest estimated well to wheel emissions value. In some embodiments, modifying the route of the vehicle 202 to include the at least one eligible refueling station (e.g., rerouting the vehicle 202) includes causing the operator I/O device 230 of the vehicle 202 to display the modified route.

At process 324, the controller 208 performs a handshake with the refueling station. In an example embodiment, controller 208 sends at least one of the third-party computing systems 190 a first well to station emissions value regarding the available fuel at a first refueling station. The first well to station emissions value regarding the available fuel at the first refueling station may be one of the well to station emissions values received at process 306. The controller 208 may subsequently receive, from the third-party computing system 190, (i) an indication that the fuel available at the first refueling station has a well to station emissions value that is at or above the first well to station emissions value or (ii) an indication that the fuel available at the first refueling station has a well to station emissions value that is below the first well to station emissions value. Responsive to receiving the indication that the fuel available at the first refueling station has a well to station emissions value that is at or above the first well to station emissions value, the controller 208 may return to process 322 to reroute the vehicle 202 to a second refueling station, different than the first refueling station and/or the remote computing system 110 may return to process 306 to receive a second well to station emissions value. Responsive to receiving the indication that the fuel available at the first refueling station has a well to station emissions value that is below the first well to station emissions value, the controller 208 may cause the vehicle 202 to proceed to the first refueling station. In some embodiments, after process 324, the controller 208 may perform the method 400 to audit the refueling event.

Now referring to FIG. 4, a flow diagram of a method 400 of auditing a refueling event is shown, according to an example embodiment. In some embodiments, the remote computing system 110, or a component thereof, such as the powertrain control circuit 120, is structured to perform the method 400 alone, or in combination with one or more components/systems of the system 100, such as one or more vehicles 202 of the fleet 200, the fleet operator computing system 180, and/or the third-party computing systems 190. In an example embodiment, the method 400 includes auditing a refueling event for at least one vehicle 202 of the fleet 200, such as a first vehicle 202. Accordingly, in the embodiments described herein, the method 400 relates to auditing a refueling event for the first vehicle 202. However, it should be understood that the method 400 may be performed concurrently, partially concurrently, and/or sequentially for each vehicle 202 in the fleet 200.

In various other embodiments of the method 400, the controller 208, or one or more components thereof, such as the powertrain control circuit 222, may perform the method 400 alone, or in combination with one or more components/systems of the system 100, such as the remote computing system 110, the fleet operator computing system 180, and/or the third-party computing systems 190.

It should be understood that certain of the method 400 processes may be combined in other embodiments; implemented in a different order than depicted in other embodiments; and, in some embodiments, certain of the method 400 processes may be deleted/omitted.

At process 402, the remote computing system 110 and/or the controller 208 receives an estimated well to wheel emissions value associated with a refueling event of the first vehicle 202. The estimated well to wheel emissions value is based on a reported well to station emissions value regarding a fuel available at a refueling station associated with the refueling event and an estimated tank to wheel emissions value. In some embodiments, the remote computing system 110 and/or the controller 208 may receive the well to station emissions value via a user input (e.g., a user input via the operator I/O device 230 of the first vehicle 202). That is, a user may indicate the well to station emissions value associated with the refueling event.

At process 404, the remote computing system 110 and/or the controller 208 receives information regarding an actual well to wheel emissions value associated with the refueling event of the first vehicle 202, after the first vehicle 202 has consumed the fuel. The information regarding the actual well to wheel emissions value is based on, for example, a received well to station emissions value regarding the fuel provided to the first vehicle 202 from a refueling station during the refueling event and the actual tank to wheel emissions value of the fuel provided to the first vehicle 202 during the refueling event. In some embodiments, the remote computing system 110 and/or the controller 208 may receive the well to wheel emissions value from a third-party computing system 190.

In some embodiments, the received well to station emissions value is received from a user device. For example, a user (e.g., an operator of the vehicle 202, an operator of the refueling station, etc.) may use a user device, such as a smartphone, a camera, a scan tool, or other suitable user device to scan a scannable code associated with the fuel provided to the vehicle 202 from the refueling station during the refueling event. The scannable code, when scanned, may provide the user device with information regarding the well to station emissions value of the fuel that is provided to the vehicle 202 during the fueling event. The remote computing system 110 and/or the controller 208 may receive the information regarding the well to station emissions value of the fuel provided to the vehicle 202 from the user device. In an example embodiment, the user device is a scan tool that is communicatively coupled to the operator I/O device 230. The remote computing system 110 and/or the controller 208 may receive the information regarding the well to station emissions value of the fuel provided to the vehicle 202 from the operator I/O device 230 (e.g., via the controller 208).

In other embodiments, the received well to station emissions value associated with the refueling event of the first vehicle 202 is based on location data associated with the first vehicle 202. For example, the remote computing system 110 and/or the controller 208 receives a location history (e.g., information regarding a set of previous locations) of the first vehicle 202. The remote computing system 110 and/or the controller 208 may identify a refueling station that is associated with the refueling event of the first vehicle 202 based on the location history of the first vehicle 202. For example, the remote computing system 110 and/or the controller 208 may determine that a first refueling station is associated with the refueling event of the first vehicle 202 responsive to determining that the location history of the first vehicle includes the first refueling station. The remote computing system 110 and/or the controller 208 may receive a well to station emissions value associated with the fuel available at the refueling station that is associated with the refueling event. In some embodiments, the well to station emissions value associated with the fuel available at the refueling station that is associated with the refueling event is received from a third-party computing system 190 associated with the refueling station. The received well to station emissions value may be used to determine the actual well to wheel emissions value associated with the refueling event.

At process 406, the remote computing system 110 and/or the controller 208 compares a difference between the actual well to wheel emissions value and the estimated well to wheel emissions value with a predetermined threshold. The remote computing system 110 and/or the controller 208 may proceed to process 410, responsive to determining that the absolute value of the difference between the actual well to wheel emissions value and the expected well to wheel emissions value is at or above the predetermined threshold. For example, when the absolute value of the difference between the actual well to wheel emissions value and the estimated well to wheel emissions value is at or above the predetermined threshold, the remote computing system 110 and/or the controller 208 may determine that the fuel received by the first vehicle 202 was not a desired fuel. For example, the remote computing system 110 and/or the controller 208 may determine that the first vehicle 202 was refueled using an undesired fuel, such as a fuel having a well to station emissions value (or a well to tank emissions value) that is at or above a predetermined threshold. The remote computing system 110 and/or the controller 208 may proceed to process 420, responsive to determining that the absolute value of the difference between the actual well to wheel emissions value and the estimated well to wheel emissions value is below the predetermined threshold. For example, when the absolute value of the difference between the actual well to wheel emissions value and the estimated well to wheel emissions value is below the predetermined threshold, the remote computing system 110 and/or the controller 208 may determine that the fuel received by the first vehicle 202 was a desired fuel. For example, the remote computing system 110 and/or the controller 208 may determine that the first vehicle 202 was refueled using a desired fuel, such as a fuel having a well to station emissions value (or a well to tank emissions value) that is below a predetermined threshold.

At process 410, the remote computing system 110 and/or the controller 208 causes the first vehicle 202 to implement a vehicle derate. For example, the remote computing system 110 and/or the controller 208 may send a command, a signal, or other instructions to the controller 208 such that the controller 208 implements a vehicle derate. The vehicle derate may include, for example, limiting a speed of the vehicle to at or below a predefined speed value, limiting an engine speed to at or below a predefined engine speed value, limiting an engine torque value to at or below a predefined torque value, and so on. In some embodiments, the remote computing system 110 and/or the controller 208 may skip process 410. In other embodiments, the remote computing system 110 and/or the controller 208 may perform process 410 concurrently, partially concurrently or sequentially with process 412, process 414, process 416, and/or process 418.

At process 412, the remote computing system 110 and/or the controller 208 receives information regarding a fuel system, such as the fuel system 270 of the first vehicle 202. In some embodiments, the information regarding the fuel system 270 includes an estimated well to wheel emissions value of fuel stored in each fuel storage tank onboard the vehicle 202. In some embodiments, when the first vehicle 202 includes a hybrid powertrain, the information regarding the fuel system 270 includes an indication of a state of charge of the battery of the fuel system 270.

At process 414, the remote computing system 110 and/or the controller 208 causes the first vehicle 202 to implement one or more fuel system controls. For example, the remote computing system 110 and/or the controller 208 may send a command, a signal, or other instructions to the controller 208 such that the controller 208 implements the one or more fuel system controls.

In some embodiments, the one or more fuel system controls includes disabling one or more fuel storage tank onboard the vehicle 202. Disabling a fuel storage tank includes preventing the disabled fuel storage tank from providing fuel to the engine 204. In some embodiments, the one or more fuel system controls includes disabling a fuel storage tank responsive to the fuel stored in the fuel storage tank having an estimated well to wheel emissions value that is at or above a predetermined value, such as the target well to wheel emissions value described herein with respect to process 304 of FIG. 3. In some embodiments, the disabled fuel storage tank may be re-enabled (e.g., allowing the re-enabled fuel storage tank to provide fuel to the engine 204) responsive to the fuel stored in the fuel storage tank having an estimated well to wheel emissions value that is below a predetermined value, such as the target well to wheel emissions value. This may occur, for example, when the first vehicle 202 exits a geographic area having a relatively lower well to wheel emissions limit compared to a current well to wheel emissions limit and/or when the first vehicle 202 exits a geographic area having a relatively higher well to wheel emissions limit compared to a current well to wheel emissions limit. That is, the predetermined value may be based on, for example, a position of the first vehicle 202 relative to the geographic area (e.g., inside the geographic area or outside the geographic area).

In some embodiments, the one or more fuel system controls includes venting hydrogen gas from one or more fuel storage tank onboard the vehicle 202. Venting hydrogen gas from a fuel storage tank includes causing the hydrogen gas in the fuel storage tank to be released to the atmosphere. In some embodiments, the one or more fuel system controls includes venting hydrogen gas from a fuel storage tank responsive to the fuel stored in the fuel storage tank having an estimated well to wheel emissions value that is at or above a predetermined value, such as the target well to wheel emissions value described herein with respect to process 304 of FIG. 3.

In some embodiments, the one or more fuel system controls includes exchanging one or more fuel storage tank onboard the vehicle 202 for a new fuel storage tank. Exchanging a fuel storage tank includes directing a user (e.g., via a human-readable display on the operator I/O device 230 or other suitable device) to remove one or more fuel storage tanks having fuel with an estimated well to wheel emissions value that is at or above a predetermined value and replacing the one or more removed fuel storage tanks with new fuel storage tanks having fuel with an estimated well to wheel emissions value that is below the predetermined value. The predetermined value may be the target well to wheel emissions value described herein with respect to process 304 of FIG. 3.

In some embodiments, when the powertrain of the vehicle 202 is a hybrid powertrain, the one or more fuel system controls includes causing a powertrain of the vehicle 202 to increase use of an electric machine relative to the use of the engine 204. In this way, the amount of fuel consumed by the engine 204 may decrease. In some embodiments, the powertrain of the vehicle 202 is caused to increase use of the electric machine relative to the use of the engine 204 responsive to the fuel stored in the fuel storage tank having an estimated well to wheel emissions value that is at or above a predetermined value, such as the target well to wheel emissions value described herein with respect to process 304 of FIG. 3, and/or responsive to the state of charge value being at or above a predetermined state of charge threshold.

In some embodiments, the remote computing system 110 and/or the controller 208 may skip process 412 and process 414. In other embodiments, the remote computing system 110 and/or the controller 208 may perform process 412 and process 414 concurrently, partially concurrently or sequentially with process 410, process 416, and/or process 418.

At process 416, the remote computing system 110 and/or the controller 208 adjusts a target well to wheel emissions value of one or more other vehicles in the fleet 200 (e.g., a second vehicle, a third vehicle, etc. that is different than the first vehicle 202). Adjusting the target well to wheel emissions value of one or more other vehicles in the fleet 200 may include decreasing a target well to wheel emissions value of the one or more vehicles relative to a current or previous target well to wheel emissions value. For example, the remote computing system 110 and/or the controller 208 may decrease the target well to wheel emissions value of a second vehicle. Advantageously, by decreasing the target well to wheel emissions value (e.g., from a first or initial target well to wheel emissions value to a second target well to wheel emissions value, less than the first target well to wheel emissions value) of the one or more other vehicles in the fleet 200 (e.g., the second vehicle), the actual well to wheel emissions value of the fleet 200 may decrease (e.g., from a first or initial fleet well to wheel emissions value to a second fleet well to wheel emissions value, less than the first fleet well to wheel emissions value) or remain constant (e.g., at or approximately at the first or initial fleet well to wheel emissions value). For example, the actual well to wheel emissions emitted by the one or more other vehicles in the fleet 200 decreased (e.g., due to the decreased target well to wheel emissions value) to account for the increase in the actual well to wheel emissions emitted by the first vehicle 202 using the undesired fuel. In some embodiments, the remote computing system 110 and/or the controller 208 may skip process 416. In other embodiments, the remote computing system 110 and/or the controller 208 may perform process 416 concurrently, partially concurrently or sequentially with process 410, process 412, process 414, and/or process 418.

At process 418, the remote computing system 110 and/or the controller 208 modifies a set of reporting data. The reporting data may include information regarding the actual well to wheel emissions associated with one or more vehicles 202 in the fleet 200, such as the first vehicle 202. The reporting data may include information regarding a cumulative amount of actual well to wheel emissions associated with all of the vehicles 202 in the fleet 200 (e.g., during a predefined period of time). As described above, responsive to determining that the difference between the actual well to wheel emissions value and the estimated well to wheel emissions value is at or above the predetermined threshold, the remote computing system 110 and/or the controller 208 may determine that the fuel received by the first vehicle 202 was not a desired fuel (e.g., an undesired fuel, such as a fuel having a well to wheel emissions value that is at or above a predetermined threshold). Advantageously, the remote computing system 110 and/or the controller 208 may modify the reporting data to include an indication that the estimated well to wheel emissions value is different from the actual well to wheel emissions value. For example, the remote computing system 110 and/or the controller 208 may automatically change a first value associated with the estimated well to wheel emissions value in the reporting data to a second value associated with the actual well to wheel emissions value and different than the first value. The second value is greater than the first value. In some embodiments, the computing system 110 may modify the reporting data to include a human-readable indication that the reporting data was modified. In some embodiments, the remote computing system 110 and/or the controller 208 may skip process 418. In other embodiments, the remote computing system 110 and/or the controller 208 may perform process 418 concurrently, partially concurrently or sequentially with process 410, process 412, process 414, and/or process 416.

At process 420, responsive to determining that the difference between the actual well to wheel emissions value and the estimated well to wheel emissions value is below the predetermined threshold, the remote computing system 110 and/or the controller 208 may enable “normal” vehicle operations at the first vehicle 202. Enabling the “normal” vehicle operations may include, for example, allowing the first vehicle 202 to operate according to a predefined set of instructions, inputs, or other operational characteristics, including, for example, a predefined set of engine speeds, engine actuator positions, engine temperatures, aftertreatment system temperatures, and so on that are associated with non-modified or normal operation of the vehicle 202. In some embodiments, enabling the normal vehicle operations may include allowing an operator of the first vehicle 202 and/or the controller 208 of the first vehicle 202 to select the predefined set of instructions for operating the first vehicle 202. In other embodiments, when the method 400 is performed by the remote computing system 110, enabling the normal vehicle operations may include disabling or preventing control of the first vehicle 202 by the remote computing system 110 by, for example, disabling or preventing the remote computing system 110 from sending instructions to the first vehicle 202, or, more specifically, to the controller 208. In some embodiments, the remote computing system 110 may disable or prevent the remote computing system 110 from sending instructions to the first vehicle 202 for a predetermined amount of time and/or until a subsequent refueling event of the first vehicle 202 occurs.

In other embodiments, when the method 400 is performed by the controller 208, enabling the normal vehicle operations may include disabling or preventing control of the first vehicle 202 by the remote computing system 110 by, for example, disabling or preventing the remote computing system 110 from sending instructions to the vehicle 202, or, more specifically, to the controller 208. In some embodiments, the controller 208 may disable or prevent the remote computing system 110 from sending instructions to the vehicle 202 for a predetermined amount of time and/or until a subsequent refueling event of the vehicle 202 occurs.

In some embodiments, the remote computing system 110 and/or the controller 208 may skip process 420. In other embodiments, the remote computing system 110 and/or the controller 208 may perform process 420 concurrently, partially concurrently or sequentially with process 422.

At process 422, the remote computing systems 110 and/or the controller 208 provides the reporting data to one or more third-party computing systems 190. In some embodiments, the remote computing systems 110 and/or the controller 208 provides the reporting data responsive to receiving a request for the reporting data. In some embodiments, the remote computing systems 110 and/or the controller 208 provides the reporting data at a predetermined time interval (e.g., once per day, once per week, once per month, etc.). In some embodiments, the remote computing systems 110 and/or the controller 208 provides the reporting data in real-time (e.g., every second, every millisecond, etc.). In some embodiments, the reporting data may be modified reporting data (e.g., reporting data that is modified at process 418). In some embodiments, the remote computing system 110 and/or the controller 208 may skip process 422. In other embodiments, the remote computing system 110 and/or the controller 208 may perform process 422 concurrently, partially concurrently or sequentially with process 420.

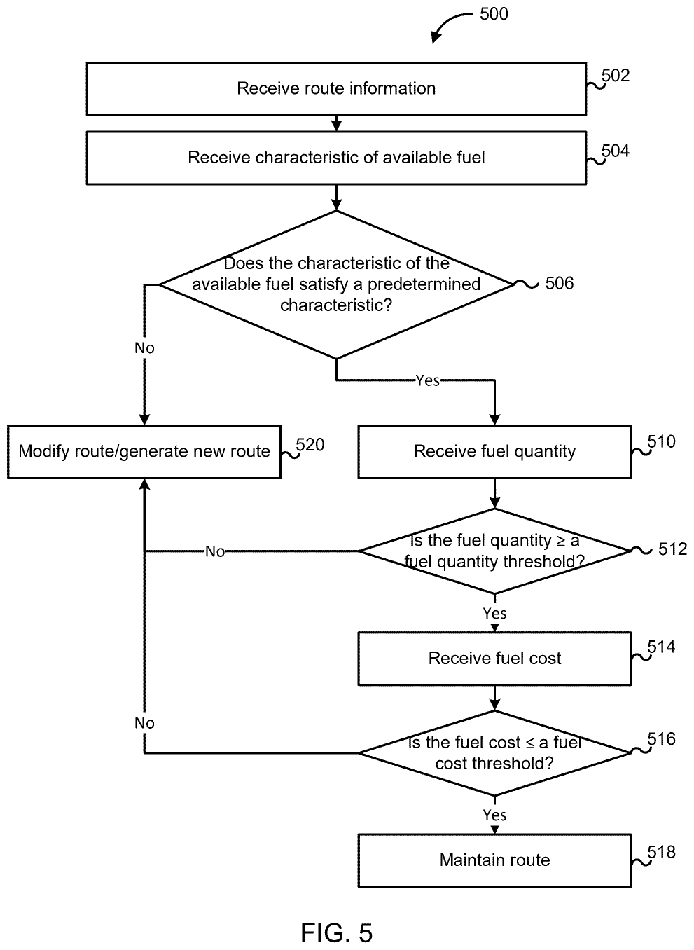

Now referring to FIG. 5, a flow diagram of a method 500 of routing a vehicle 202 to a refueling station is shown, according to an example embodiment. In some embodiments, the remote computing system 110, or a component thereof, such as the powertrain control circuit 120, is structured to perform the method 500 alone, or in combination with one or more components/systems of the system 100, such as one or more vehicles 202 of the fleet 200, the fleet operator computing system 180, and/or the third-party computing systems 190. In an example embodiment, the method 500 includes routing at least one vehicle 202 of the fleet 200, such as a first vehicle 202, to a fueling station having a desired fuel classifications (e.g., green hydrogen, blue hydrogen, etc.). Accordingly, in the embodiments described herein, the method 500 relates to routing the first vehicle 202 to a fueling station. However, it should be understood that the method 500 may be performed concurrently, partially concurrently, and/or sequentially for each vehicle 202 in the fleet 200. It should be understood that certain of the method 500 processes may be combined in other embodiments; implemented in a different order than depicted in other embodiments; and, in some embodiments, certain of the method 500 processes may be deleted/omitted.

In various other embodiments of the method 500, the controller 208, or one or more components thereof, such as the powertrain control circuit 222, may perform the method 500 alone, or in combination with one or more components/systems of the system 100, such as the remote computing system 110, the fleet operator computing system 180, and/or the third-party computing systems 190.

At process 502, the remote computing system 110 and/or the controller 208 receives route information regarding a first vehicle 202 of the fleet 200. In some embodiments, the vehicle route information includes at least a first fueling station. More specifically, the route may direct the vehicle 202 to at least the first fueling station. The route information is further described herein with respect to process 302 of FIG. 3.

At process 504, the remote computing system 110 and/or the controller 208 receives information regarding a characteristic of the available fuel at the first fueling station. The available fuel may be hydrogen fuel that is available to the first vehicle 202 at the first fueling station. In some embodiments, the remote computing system 110 and/or the controller 208 is configured to receive information from at least one of the third-party computing systems 190 regarding the characteristic of the available fuel at the first fueling station. In some embodiments, the characteristic of the available fuel is the fuel classification of the available fuel. For example, the characteristic of the available fuel may be “green hydrogen,” “blue hydrogen,” “yellow hydrogen,” “brown hydrogen,” or other hydrogen classification.

At process 506, the remote computing system 110 and/or the controller 208 compares the received characteristic of the available fuel to at least one predetermined characteristic. The predetermined characteristic may be a desired fuel classification. For example, the predetermined characteristics may be one or more of “green hydrogen,” “yellow hydrogen,” “white hydrogen,” “pink hydrogen,” and/or another desired hydrogen classification. Responsive to the received characteristic of the available fuel satisfying (e.g., matching) the predetermined characteristic, the method 500 may proceed to process 510. The received characteristic of the available fuel may satisfy the predetermined characteristic when the received characteristic of the available fuel is the same as at least one of the predetermined characteristics. Responsive to the received characteristic of the available fuel not satisfying (e.g., not matching) the predetermined characteristic, the method 500 may proceed to process 520. The received characteristic of the available fuel may not satisfy the predetermined characteristic when the received characteristic of the available fuel is different than the predetermined characteristic(s).

At process 510, the remote computing system 110 and/or the controller 208 receives a fuel quantity value regarding the available fuel. In some embodiments, the remote computing system 110 and/or the controller 208 is configured to receive information from at least one of the third-party computing systems 190 regarding the fuel quantity value of the available fuel at the first fueling station. In some embodiments, the fuel quantity value of the available fuel is an amount (e.g., mass, volume, etc.) of the available fuel at the first fueling station.

At process 512, the remote computing system 110 and/or the controller 208 compares the fuel quantity value to a predetermined threshold (e.g., a fuel quantity threshold). The predetermined threshold may be a desired amount (e.g., mass, volume, etc.) of fuel for a refueling event. The predetermined threshold is based on (e.g., at or above) a desired amount of fuel for the first vehicle 202 to receive during a fueling event. In some embodiments, the desired amount of fuel is based on a current amount of fuel stored by the first vehicle 202 and a target fuel value. The target fuel value is a desired amount of fuel to be stored by the fuel system 270 of the first vehicle 202. The target fuel value may be based on the mission of the first vehicle 202. For example, the target fuel value may be based on an amount of fuel needed to complete the mission or a portion thereof. Responsive to the fuel quantity value being below the predetermined threshold, the method 500 may proceed to process 520. Responsive to the fuel quantity value being at or above the predetermined threshold, the method 500 may proceed to process 514.

At process 514, the remote computing system 110 and/or the controller 208 receives a value associated with the available fuel (e.g., a “fuel cost value” regarding the available fuel). In some embodiments, the remote computing system 110 and/or the controller 208 is configured to receive information from at least one of the third-party computing systems 190 regarding the fuel cost value of the available fuel at the first fueling station. In some embodiments, the fuel cost value of the available fuel is a cost (e.g., price) of the available fuel at the first fueling station, such as a cost per unit of fuel (e.g., a cost per kilogram of fuel, a cost per liter of fuel, etc.). The fuel cost value may be based on a cost per unit of the available fuel at the first fueling station and a desired amount of fuel, such that the fuel cost value is the cost per unit of fuel multiplied by the desired amount of fuel. In some embodiments, the remote computing system 110 and/or the controller 208 may receive the cost per unit fuel from one or more third-party computing systems 190 associated with the fueling station or another service provider. In other embodiments, the remote computing system 110 and/or the controller 208 may receive the cost per unit fuel via a user input. In an example embodiment, if the cost per unit of fuel is $10 per kilogram of hydrogen, and the desired amount of fuel is 2 kilograms of hydrogen, the fuel cost value is $20.

At process 516, the remote computing system 110 and/or the controller 208 compares the fuel cost value to a predetermined threshold (e.g., a fuel cost threshold). The predetermined threshold may be a desired cost of fuel for a refueling event. The predetermined threshold may be based on a desired cost of fuel for the first vehicle 202. In some embodiments, the desired cost of fuel is a predetermined value. Responsive to the fuel cost value being below the predetermined threshold, the method 500 may proceed to process 520. Responsive to the fuel cost value being at or above the predetermined threshold, the method 500 may proceed to process 518.

At process 518, the remote computing system 110 and/or the controller 208 maintains the current route of the vehicle 202. In some embodiments, the remote computing system 110 and/or the controller 208 may provide a notification indicating that the current route is an acceptable route. In some embodiments, the remote computing system 110 and/or the controller 208 may provide the notification to the operator I/O device 230 of the first vehicle 202 and/or to a user device, such as a smartphone or tablet.

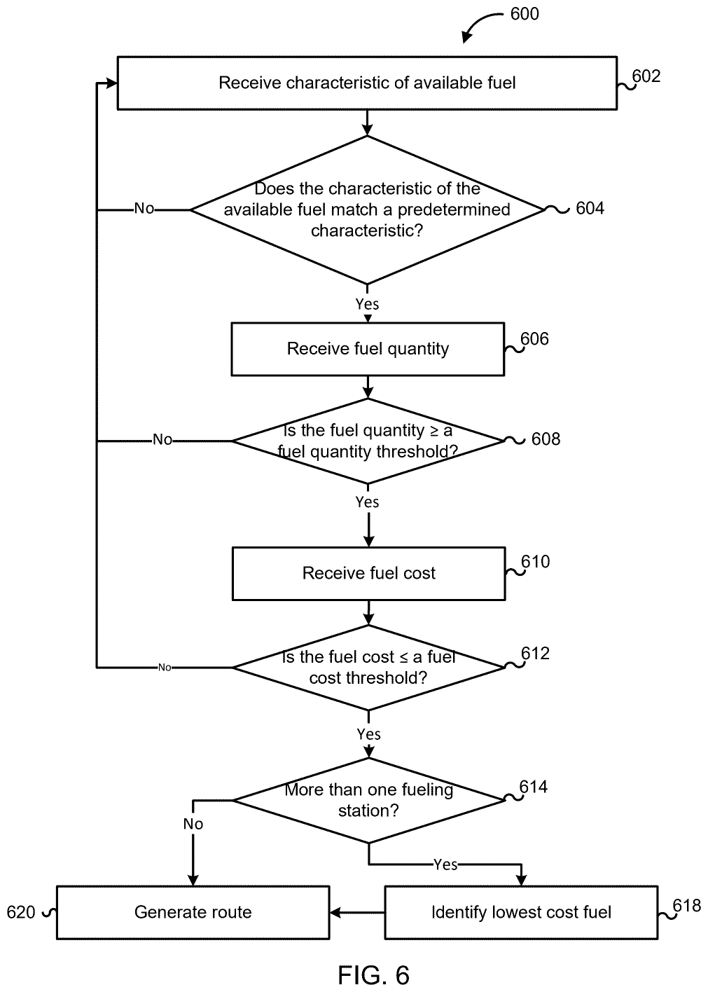

At process 520, responsive to at least one of (i) the first characteristic being different than the predetermined characteristic, (ii) the fuel quantity value being at or below the predetermined threshold, or (iii) the cost value being at or above the predetermined threshold, the remote computing system 110 and/or the controller 208 may modify the route received at process 502 and/or generate a new route. In some embodiments, modifying the route includes modifying the route to exclude the first fueling station. In some embodiments, modifying the route includes modifying the route to includes a second fueling station, different than the first fueling station. In some embodiments, the remote computing system 110 and/or the controller 208 may generate a new route. An example method of generating a new route is described herein with respect to FIG. 6.

Now referring to FIG. 6, a flow diagram of a method 600 of generating a route for a vehicle 202 is shown, according to an example embodiment. In some embodiments, the remote computing system 110, or a component thereof, such as the powertrain control circuit 120, is structured to perform the method 600 alone, or in combination with one or more components/systems of the system 100, such as one or more vehicles 202 of the fleet 200, the fleet operator computing system 180, and/or the third-party computing systems 190. In an example embodiment, the method 600 includes routing at least one vehicle 202 of the fleet 200, such as a first vehicle 202, to a fueling station having a desired fuel classifications (e.g., green hydrogen, blue hydrogen, etc.). Accordingly, in the embodiments described herein, the method 600 relates to routing the first vehicle 202 to a fueling station. However, it should be understood that the method 600 may be performed concurrently, partially concurrently, and/or sequentially for each vehicle 202 in the fleet 200. It should be understood that certain of the method 600 processes may be combined in other embodiments; implemented in a different order than depicted in other embodiments; and, in some embodiments, certain of the method 600 processes may be deleted/omitted.

In various other embodiments of the method 600, the controller 208, or one or more components thereof, such as the powertrain control circuit 222, may perform the method 600 alone, or in combination with one or more components/systems of the system 100, such as the remote computing system 110, the fleet operator computing system 180, and/or the third-party computing systems 190.

At process 602, the remote computing system 110 and/or the controller 208 receives information regarding a characteristic of the available fuel each of a plurality of fueling stations. The available fuel may be hydrogen fuel that is available to the first vehicle 202 at each of the fueling station. In some embodiments, the remote computing system 110 and/or the controller 208 is configured to receive information from at least one of the third-party computing systems 190 regarding the characteristic of the available fuel at each of the fueling stations. In some embodiments, the characteristic of the available fuel is the fuel classification of the available fuel. For example, the characteristic of the available fuel may be “green hydrogen,” “blue hydrogen,” “yellow hydrogen,” “brown hydrogen,” or other hydrogen classification. In an example embodiment, the remote computing system 110 and/or the controller 208 may receive a first characteristic of a first fuel at a first fueling station and a second characteristic of a second fuel at a second fueling station, different than the first fueling station.

At process 604, the remote computing system 110 and/or the controller 208 compares the received characteristics of the available fuel to at least one predetermined characteristic. The predetermined characteristic may be a desired fuel classification. For example, the predetermined characteristics may be one or more of “green hydrogen,” “yellow hydrogen,” “white hydrogen,” “pink hydrogen,” and/or another desired hydrogen classification. The remote computing system 110 and/or the controller 208 may compare each of the received characteristics of the available fuel to the at least one predetermined characteristic concurrently, partially concurrently, or sequentially. In some embodiments, the remote computing system 110 and/or the controller 208 may compare each of the received characteristics of the available fuel to at least one predetermined characteristic before proceeding to a subsequent process of the method 600.

The method 600 may proceed to process 606 for each fueling station having a corresponding characteristic of the available fuel that satisfies the predetermined characteristic. The characteristic of the available fuel may satisfy the predetermined characteristic when the received characteristic of the available fuel is the same as at least one of the predetermined characteristics. The method 600 may return to process 602 for each fueling station having a corresponding characteristic of the available fuel that that does not satisfy the predetermined characteristic. The received characteristic of the available fuel may not satisfy the predetermined characteristic when the received characteristic of the available fuel is different than the predetermined characteristics. When returning to process 602, the remote computing system 110 and/or the controller 208 may flag the fueling stations having a corresponding characteristic of the available fuel that that does not satisfy the predetermined characteristic as being unavailable. When a fueling station is flagged as being unavailable, the remote computing system 110 and/or the controller 208 is prevented from generating a route that includes the unavailable fueling station.

At process 606, the remote computing system 110 and/or the controller 208 receives a fuel quantity value regarding the available fuel. In some embodiments, the remote computing system 110 and/or the controller 208 is configured to receive information from at least one of the third-party computing systems 190 regarding the fuel quantity value of the available fuel at each of the first fueling stations. In some embodiments, the remote computing system 110 and/or the controller 208 may receive the fuel quantity value for each fueling station having a corresponding characteristic of the available fuel that satisfies the predetermined characteristic. In some embodiments, the fuel quantity value of the available fuel is an amount (e.g., mass, volume, etc.) of the available fuel at a corresponding fueling station.

At process 608, the remote computing system 110 and/or the controller 208 compares the fuel quantity value to a predetermined threshold (e.g., a fuel quantity threshold). The predetermined threshold may be a desired amount (e.g., mass, volume, etc.) of fuel for a refueling event. The predetermined threshold may be based on a desired amount of fuel for the first vehicle 202 to receive during a fueling event. In some embodiments, the desired amount of fuel is based on a current amount of fuel stored by the first vehicle 202 and a target fuel value. The target fuel value may be based on the mission of the first vehicle 202. For example, the target fuel value may be based on an amount of fuel needed to complete the mission or a portion thereof. The remote computing system 110 and/or the controller 208 may compare each of the received fuel quantity values to the predetermined threshold concurrently, partially concurrently, or sequentially. In some embodiments, the remote computing system 110 and/or the controller 208 may compare each of the received fuel quantity values to the predetermined threshold before proceeding to a subsequent process of the method 600.

The method 600 may proceed to process 610 for each fueling station having a corresponding fuel quantity value of the available fuel that is above the predetermined threshold. The method 600 may return to process 602 for each fueling station having a corresponding fuel quantity value that is at or below the predetermined threshold. When returning to process 602, the remote computing system 110 and/or the controller 208 may flag the fueling stations having a corresponding fuel quantity value of the available fuel that that is at or below the predetermined threshold as being unavailable. As described above, when a fueling station is flagged as being unavailable, the remote computing system 110 and/or the controller 208 is prevented from generating a route that includes the unavailable fueling station.

At process 610, the remote computing system 110 and/or the controller 208 receives a fuel cost value regarding the available fuel. In some embodiments, the remote computing system 110 and/or the controller 208 is configured to receive information from at least one of the third-party computing systems 190 regarding the fuel cost value of the available fuel at each of the fueling stations. In some embodiments, the remote computing system 110 and/or the controller 208 may receive the fuel cost value for each fueling station having a corresponding characteristic of the available fuel that satisfies the predetermined characteristic. In some embodiments, the fuel cost value of the available fuel is cost (e.g., price) of the available fuel at a corresponding fueling station.

At process 612, the remote computing system 110 and/or the controller 208 compares the fuel cost value to a predetermined threshold (e.g., a fuel cost threshold). The predetermined threshold may be a desired cost of fuel for a refueling event. The remote computing system 110 and/or the controller 208 may compare each of the received fuel cost values to the predetermined threshold concurrently, partially concurrently, or sequentially. In some embodiments, the remote computing system 110 and/or the controller 208 may compare each of the received fuel cost values to the predetermined threshold before proceeding to a subsequent process of the method 600.

The method 600 may proceed to process 614 for each fueling station having a corresponding fuel cost value of the available fuel that is below the predetermined threshold. The method 600 may return to process 602 for each fueling station having a corresponding fuel cost value that is at or above the predetermined threshold. When returning to process 602, the remote computing system 110 and/or the controller 208 may flag the fueling stations having a corresponding fuel cost value of the available fuel that that is at or above the predetermined threshold as being unavailable. As described above, when a fueling station is flagged as being unavailable, the remote computing system 110 and/or the controller 208 is prevented from generating a route that includes the unavailable fueling station.

At process 614, the remote computing system 110 and/or the controller 208 determines whether more than one fueling station is available. In particular, the remote computing system 110 and/or the controller 208 may receive a number of fueling stations that satisfy three conditions. For example, the remote computing system 110 and/or the controller 208 may receive a number of fueling stations that (i) have a corresponding characteristic of the available fuel that satisfies the predetermined characteristic, (ii) have a corresponding fuel quantity value of the available fuel that is above the predetermined threshold, and/or (iii) have a corresponding fuel cost value of the available fuel that is below the predetermined threshold. Responsive to the number of fueling stations being two or more, the method 600 proceed to process 618. Responsive to the number of fueling stations being one, the method 600 proceed to process 620.

At process 618, the remote computing system 110 and/or the controller 208 identifies a lowest cost fuel. For example, the remote computing system 110 and/or the controller 208 may compare each of the fuel cost values to each other and identify a fueling station having the lowest fuel cost value. Responsive to identifying the fueling station having the lowest fuel cost value, the method 600 proceeds to process 620.

In some embodiments, process 606, process 608, process 610, process 612, process 614, and/or process 618 are optional. In these embodiments, the remote computing system 110 and/or the controller 208 may skip any one of process 606, process 608, process 610, process 612, process 614, and/or process 618.

At process 620, the remote computing system 110 and/or the controller 208 may generate a route for the vehicle 202 that includes an identified fueling station. In some embodiments, the identified fueling station is the one fueling station identified at process 614 (e.g., when only one fueling station satisfies the three conditions). In other embodiments, the identified fueling station is the fueling station having the lowest fuel cost value, identified at process 618.

Generating the route includes, for example, generating turn-by-turn directions between a current location of the vehicle 202 and the identified fueling station. In some embodiments, the remote computing system 110 and/or the controller 208 may provide the route to an operator of the vehicle 202. For example, the remote computing system 110 and/or the controller 208 may provide the route to the operator I/O device 230 of the first vehicle 202 and/or to a user device, such as a smartphone or tablet.

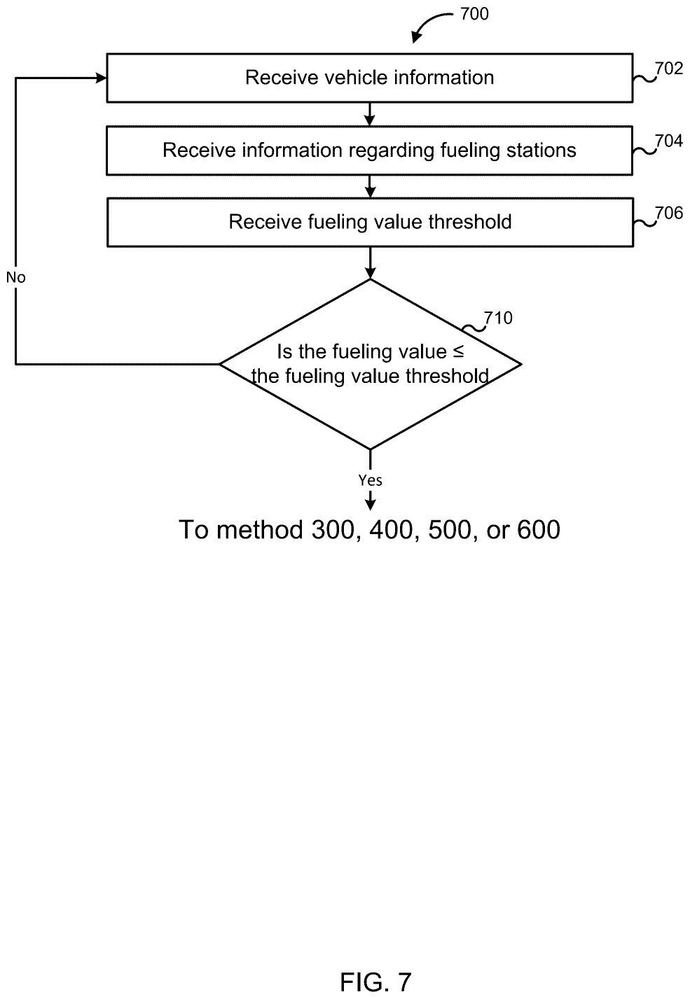

Now referring to FIG. 7, a flow diagram of a method 700 of identifying a fueling opportunity for the vehicle 202 is shown, according to an example embodiment. In some embodiments, the remote computing system 110, or a component thereof, such as the powertrain control circuit 120, is structured to perform the method 700 alone, or in combination with one or more components/systems of the system 100, such as one or more vehicles 202 of the fleet 200, the fleet operator computing system 180, and/or the third-party computing systems 190.

In various other embodiments of the method 700, the controller 208, or one or more components thereof, such as the powertrain control circuit 222, may perform the method 700 alone, or in combination with one or more components/systems of the system 100, such as the remote computing system 110, the fleet operator computing system 180, and/or the third-party computing systems 190.

In an example embodiment, the method 700 includes identifying a fueling opportunity for the vehicle 202. In an example operating scenario, a vehicle, such as the vehicle 202, must stop at a fueling station to refuel, increasing the duration of a mission of the vehicle. Thus, it is desirable to stop for fuel only when necessary to complete the mission (or a segment thereof). Advantageously, the method 700 includes identifying fueling opportunities for the vehicle 202 to mitigate or avoid unnecessary stops. For example, the fueling opportunities may be based on an amount of fuel stored by the vehicle 202 (e.g., at the fuel system 270), an amount of potential refueling opportunities, and/or the type of hydrogen available for each of the refueling opportunities.

It should be understood that the method 700 may be performed concurrently, partially concurrently, and/or sequentially for each vehicle 202 in the fleet 200. It should be understood that certain of the method 700 processes may be combined in other embodiments; implemented in a different order than depicted in other embodiments; and, in some embodiments, certain of the method 700 processes may be deleted/omitted. Furthermore, the method 700 may be performed concurrently, partially concurrently, or sequentially with the method 300, the method 400, the method 500, and/or the method 600. In one embodiment, and as shown in FIG. 7, the method 300, the method 400, the method 500, and/or the method 600 may be performed after the method 700. In another embodiment, the method 700 may be performed partially concurrently with the method 300. For example, the method 700 may be performed concurrently with process 320 of the method 300.

At process 702, the remote computing system 110 and/or the controller 208 receives vehicle information regarding the vehicle 202. In some embodiments, the vehicle information includes a fueling value regarding the vehicle 202. The fueling value is an amount of fuel stored by the fuel system 270 (which may be expressed as a mass, a weight, or a volume). In some embodiments, the vehicle information includes information regarding a mission of the vehicle, such as a route, an origin location, a destination location, and so on.

At process 704, the remote computing system 110 and/or the controller 208 receives information regarding one or more fueling stations. The information regarding the one or more fueling stations may include, for example, a distance between the one or more fueling stations and the vehicle 202. In some embodiments, the remote computing system 110 and/or the controller 208 receives information regarding one or more fueling stations that are within a predetermined distance of the vehicle 202 and/or that are within a predetermined distance of a route of the vehicle 202. The information regarding the one or more fueling stations may include a characteristic of the available fuel at the first fueling station. The available fuel may be hydrogen fuel that is available to the first vehicle 202 at the first fueling station. In some embodiments, the remote computing system 110 and/or the controller 208 is configured to receive information from at least one of the third-party computing systems 190 regarding the characteristic of the available fuel at the first fueling station. In some embodiments, the characteristic of the available fuel is the fuel classification of the available fuel. For example, the characteristic of the available fuel may be “green hydrogen,” “blue hydrogen,” “yellow hydrogen,” “brown hydrogen,” or other hydrogen classification.

At process 706, the remote computing system 110 and/or the controller 208 receives a fueling value threshold. The fueling value threshold may be the target fuel value. As described above, the target fuel value is a desired amount of fuel to be stored by the fuel system 270 of the first vehicle 202. It is desirable to refuel the vehicle when the fueling value is at or below the fueling value threshold to mitigate stopping for fuel when fuel is not needed and to mitigate low fueling values (e.g., running low on fuel or running out of fuel).

In some embodiments, the target fuel value and, by extension, the fueling value threshold, is based on the mission of the first vehicle 202. For example, the fueling value threshold may be based on an amount of fuel needed to complete the mission or a portion thereof.

In some embodiments, the fueling value threshold is based on the information regarding the fueling stations. In one example embodiment, the fueling value threshold may be based on the number of refueling stations within a predetermined distance of the first vehicle 202 and/or a route of the first vehicle 202. The predetermined distance is or is based on a current range of the vehicle 202 (e.g., based on an amount of fuel stored by the fuel system 270 and a fuel economy of the engine 204). In another example embodiment, the fueling value threshold may be based on the number of refueling stations within the predetermined distance of the first vehicle 202 and/or a route of the first vehicle 202 and a characteristic of the available fuel at the fueling stations. For example, the fueling value threshold may be based on the number of refueling stations that both (i) have available fuel with a characteristic that matches at least one predetermined characteristic and (ii) are within the predetermined distance.

As the number of refueling stations having available fuel with a characteristic that matches at least one predetermined characteristic and/or are within the predetermined distance decreases, the fueling value threshold increases. That is, as the vehicle 202 has fewer opportunities to refuel (e.g., because fewer refueling stations are nearby and/or because fewer fueling stations that have the correct type of fuel are nearby), the fueling value threshold increases, such that the first vehicle 202 stops to refuel more frequently. Thus, increasing the fueling value threshold when the refueling opportunities are lower may mitigate low fueling values.

As the number of refueling stations having available fuel with a characteristic that matches at least one predetermined characteristic and/or are within the predetermined distance increases, the fueling value threshold decreases. That is, as the vehicle 202 has more opportunities to refuel (e.g., because more refueling stations are nearby and/or because more fueling stations that have the correct type of fuel are nearby), the fueling value threshold decreases, such that the first vehicle 202 stops to refuel less frequently. Thus, decreasing the fueling value threshold when the refueling opportunities are higher may mitigate stopping for fuel when fuel is not needed or is readily available.

At process 710, the remote computing system 110 and/or the controller 208 compares the fueling value to the fueling value threshold. Responsive to the fueling value being above the fueling value threshold, the method 700 returns to process 702. Responsive to the fueling value being at or below the fueling value threshold, the method 700 may proceed to any one of the method 300, the method 400, the method 500, or the method 600. In some embodiments, the method 700 is performed before and/or at least partially concurrently with the method 300, the method 400, the method 500, and/or the method 600. In other embodiments, the method 700 is optional and may be omitted.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 208 may include any number of circuits for completing the functions described herein. For example, the activities and functionalities of the powertrain control circuit 222 may be combined in multiple circuits or as a single circuit. Additional circuits with additional functionality may also be included. Further, the controller 208 may further control other activity beyond the scope of the present disclosure.

As mentioned above and in one configuration, the “circuits” may be implemented in machine-readable medium for execution by one or more of various types of processors, such as the processor 214 of FIG. 2. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A system comprising:
a processing circuit comprising one or more processors and one or more memory devices storing instructions that, when executed by the one or more processors, cause the one or more processors to perform operations comprising:
receiving route information comprising a route of a first vehicle;
receiving a target well to wheel emissions value associated with at least the first vehicle;
receiving a first well to wheel emissions value regarding a first available fuel;
comparing the first well to wheel emissions value to a predetermined threshold, the predetermined threshold based on the target well to wheel emissions value;
identifying a first fueling station associated with the first available fuel responsive to the first well to wheel emissions value being below the predetermined threshold; and
modifying the route of the first vehicle to include the first fueling station responsive to identifying the first fueling station.

2. The system of claim 1, wherein the target well to wheel emissions value is associated with a fleet of vehicles comprising at least the first vehicle.

3. The system of claim 2, wherein the instructions, when executed by the one or more processors, further cause the one or more processors to perform operations comprising:
receiving a current fleet well to wheel emissions value regarding the fleet of vehicles responsive to the first well to wheel emissions value being at or above the predetermined threshold;
determining a new fleet well to wheel emissions value based on at least the first well to wheel emissions value;
comparing the new fleet well to wheel emissions value to a predetermined fleet threshold;
identifying the first fueling station associated with the first available fuel responsive to the new fleet well to wheel emissions value being below the predetermined fleet threshold; and
receiving a second well to wheel emissions value of a second available fuel responsive to the new fleet well to wheel emissions value being at or above the predetermined fleet threshold.

4. The system of claim 3, wherein the instructions, when executed by the one or more processors, further cause the one or more processors to perform operations comprising:
comparing the second well to wheel emissions value to the predetermined threshold;
identifying a second fueling station associated with the second available fuel responsive to the second well to wheel emissions value being below the predetermined threshold; and
modifying the route of the first vehicle to include the second fueling station responsive to identifying the second fueling station.

5. The system of claim 1, wherein the instructions, when executed by the one or more processors, further cause the one or more processors to perform operations comprising:
providing, to a third-party computing system, a first well to station emissions value based on the first well to wheel emissions value;
receiving, from the third-party computing system one of:
a first indication that the first available fuel at the first fueling station has a second well to station emissions value that is at or above the first well to station emissions value, or
a second indication that the first available fuel at the first fueling station has the second well to station emissions value that is below the first well to wheel emissions value;
receiving a second well to wheel emissions value of a second available fuel responsive to receiving the first indication; and
sending a signal to a remote computing system indicating that the first vehicle will proceed to the first fueling station responsive to receiving the second indication.

6. The system of claim 1, wherein the instructions, when executed by the one or more processors, further cause the one or more processors to perform operations comprising causing an operator input/output device to display the route in response to modifying the route to include the first fueling station.

7. A method of auditing a refueling event comprising:
receiving an expected well to wheel emissions value;
receiving an actual well to wheel emissions value;
comparing a difference between the expected well to wheel emissions value and the actual well to wheel emissions value to a predetermined threshold;
responsive to determining that the difference between the actual well to wheel emissions value and the expected well to wheel emissions value is below the predetermined threshold, providing a reporting data set to a third-party computing system; and
responsive to determining that the difference between the actual well to wheel emissions value and the expected well to wheel emissions value is at or above the predetermined threshold, performing operations including implementing a vehicle derate via a controller of a first vehicle.

8. The method of claim 7, further comprising, responsive to determining that the difference between the actual well to wheel emissions value and the expected well to wheel emissions value is below the predetermined threshold, preventing control of the first vehicle by a remote computing system by preventing the remote computing system from sending instructions to the controller, wherein the instructions control at least one of an engine of the first vehicle, an electric machine of the first vehicle, or an aftertreatment system or component thereof of the first vehicle.

9. The method of claim 7, further comprising:
responsive to determining that the difference between the actual well to wheel emissions value and the expected well to wheel emissions value is at or above the predetermined threshold, receiving information regarding a fuel system of the first vehicle comprising an estimated well to wheel emissions value of a fuel stored in a fuel storage tank;
disabling the fuel storage tank from providing fuel to an engine of the first vehicle responsive to the estimated well to wheel emissions value being at or above a predetermined value; and
re-enabling the fuel storage tank to provide fuel to the engine of the first vehicle responsive to the estimated well to wheel emissions value being below the predetermined value;
wherein the predetermined value is based on a position of the first vehicle relative to a geographic area.

10. The method of claim 7, further comprising:
responsive to determining that the difference between the actual well to wheel emissions value and the expected well to wheel emissions value is at or above the predetermined threshold, receiving information regarding a fuel system of the first vehicle comprising an estimated well to wheel emissions value of a fuel stored in a fuel storage tank; and
venting the fuel stored in the fuel storage tank responsive to the estimated well to wheel emissions value being at or above a predetermined value.

11. The method of claim 7, further comprising:
responsive to determining that the difference between the actual well to wheel emissions value and the expected well to wheel emissions value is at or above the predetermined threshold, receiving information regarding a fuel system of the first vehicle comprising an estimated well to wheel emissions value of a fuel stored in a fuel storage tank and a state of charge of an energy storage device; and
increasing a use of an electric machine relative to an engine of the first vehicle responsive to the estimated well to wheel emissions value being at or above a predetermined value and the state of charge value being at or above a predetermined state of charge threshold.

12. The method of claim 7, further comprising responsive to determining that the difference between the actual well to wheel emissions value and the expected well to wheel emissions value is at or above the predetermined threshold, adjusting a target well to wheel emissions for a second vehicle, different than the first vehicle.

13. The method of claim 7, further comprising modifying a set of reporting data, the set of reporting data include information regarding the actual well to wheel emissions value, a modified set of reporting data including an indication that the expected well to wheel emissions value is different from the actual well to wheel emissions value.

14. A method comprising:
receiving a route of a vehicle, the route including at least a first fueling station;
receiving a first characteristic of a first fuel at the first fueling station;
comparing the first characteristic of the first fuel to a predetermined characteristic; and
responsive to the first characteristic being different than the predetermined characteristic, modifying the route to exclude the first fueling station.

15. The method of claim 14, wherein the first characteristic is a classification of the first fuel.

16. The method of claim 14, further comprising:
receiving value associated with the first fuel;
comparing the value associated with the first fuel to a predetermined threshold; and
responsive to the value associated with the first fuel being at or above the predetermined threshold, modifying the route to exclude the first fueling station.

17. The method of claim 14, further comprising:
receiving a fuel quantity value of the first fuel;
comparing the fuel quantity value of the first fuel to a predetermined threshold; and
responsive to the fuel quantity value being at or below the predetermined threshold, modifying the route to exclude the first fueling station.

18. The method of claim 14, wherein modifying the route to exclude the first fueling station comprises modifying the route to include a second fueling station, different than the first fueling station.

19. The method of claim 18, modifying the route to include the second fueling station comprises:
receiving a second characteristic of a second fuel at a second fueling station;
comparing the second characteristic to a predetermined characteristic;
responsive to the second characteristic satisfying the predetermined characteristic, modifying the route to include the second fueling station.

20. The method of claim 14, wherein modifying the route to exclude the first fueling station comprises generating a new route comprising:
receiving a second characteristic of a second fuel at a second fueling station;
receiving a third characteristic of a third fuel at a third fueling station;
comparing the second characteristic to a predetermined characteristic;
responsive to the second characteristic satisfying the predetermined characteristic, generating a first route that includes the first fueling station;
responsive to the second characteristic being different than the predetermined characteristic, comparing the third characteristic to the predetermined characteristic; and
responsive to the third characteristic satisfying the predetermined characteristic, generating a second route that includes the third fueling station.
